(19) United States
(12) Patent Application Publication
(10) Pub. No.: US 2020/0220293 A1
(43) Pub. Date: Jul. 9, 2020

(54) Modular Electrical Connector Unit

(71) Applicant: Jonathan Cox, Avon, CT (US)

(72) Inventor: Jonathan Cox, Avon, CT (US)

(21) Appl. No.: 16/733,719

(22) Filed: Jan. 3, 2020

Related U.S. Application Data
(60) Provisional application No. 62/788,100, filed on Jan. 3, 2019.

(51) Int. Cl. H01R 13/514; H01R 13/72; H01R 13/73

(52) U.S. Cl. CPC H01R 13/514; H01R 13/73; H01R 13/72

(57) ABSTRACT

A modular electrical connector system and associated method of us may include a modular electrical connector device. The device may include a primary body unit, which may be connected to a structure's electrical wiring. The primary body unit may be connectable to a modular connection unit, which may optionally be further connectable to a face unit. The device may enable electrical connection from the modular connection unit, the face unit, or both, to the structure's electrical wiring, directly or indirectly. The modular connection unit, face unit, or both, may be removably connectable to the primary body unit. The device may be connectable to one or more add-on units, enabling electrical connectivity between the add-on units and the structure's electrical wiring.

This application claims the priority of U.S. Provisional Patent Application No. 62/788,100 filed on Jan. 3, 2019, the disclosure of which is incorporated herein in its entirety.

### BACKGROUND

The present disclosure relates generally to a modular electrical connector device. More particularly, the present disclosure relates to a device, system, and associated method of use, which can be used to prepare for and to connect electrical wiring, circuits, and devices, such as for electrical outlets, lights, junctions, switches, wiring, and other devices and systems requiring electrical connectivity.

When a connection point is being prepared for electrical devices, wiring, or systems, such as an electrical outlet, power lines are typically run to a location or electrical box or sub-unit. As multiple such locations may be required in a building or other facility, and such work is commonly done during new constructions or renovations, it may be desirable to prepare power lines or connection points prior to installation of final or supplemental power outlets, switches, or junctions. Current methods and devices commonly either leave wiring exposed, requiring significant later installation work of additional components or devices, or leave junction boxes wired, which later require significant time and effort on the part of electricians, contractors, or others, to further wire, connect to, or access. Such devices and methods prove time-consuming and can be difficult to do without significant experience or when dealing with large projects.

Current methods and devices for preparing and connection electrical outlets and junction points require time to initially install and assemble and require additional time and create difficulties in later installations of connecting components and systems. Current methods and devices further require extensive disassembly and replacement if connected devices or wiring need to be replaced, updated, or removed or accessed for other reasons, often further necessitating extensive damage to and replacement of walls and support surfaces and structures.

### SUMMARY

The present disclosure relates generally to a modular electrical connector device. More particularly, the present disclosure relates to a device, related system of components, and associated method of use, which can be used to prepare for and to connect electrical wiring, circuits, and devices, such as for electrical outlets, lights, junction and junction boxes, switches, wiring, and other devices and systems requiring electrical or other wired connectivity.

In one embodiment, the device includes a main unit which may have a frame which may support additional external components, internal components, may be attached to structural elements where the unit is being installed, or any combination of the above. The main unit may include an electrical connection feature, such as a port, spring, clip, opening, bolt, or screw, for connection of at least some of a building's electrical supply to the unit. The wiring may at least partially enter into the unit through an opening, or multiple openings, or may be connected to the unit by means known in the art, such as springs, wire locks, clips, or attached to a screw which is then tightened into or against the unit. The unit may include an opening on a second side away from where the wiring is connected to the unit, or the opening may be proximal to the wiring. The frame may include an at least partially open internal volume for electrical components, connections, or other features. The opening on the second side may be at least partially within this volume, or may extend into it. The opening and/or the internal volume may be designed such that a user of the unit may be able to access the opening or the internal volume from a first side, such as from the front of the unit.

The unit may include connection features to connect the power supply from the structure to components which may be inserted into or attached to the unit. The connection features may include junctions, such as for inserting a prong or a wire. The junctions may include electrical retention elements, such as a spring, metal barbs, plastic barbs, as well as other connection and retention means known in the art. In one embodiment, a junction may include one or more leaf springs which may be configured to deflect when a prong or wire is inserted, thus offering resistance against unintended removal or movement of the prong or wire.

The unit may be configured to enable connection of an add-on unit. The unit may include one or more electrical pathways which may, directly or indirectly, enable electricity or other wired transmission to be supplied from the structure's wiring, through the unit, to an add-on unit. The unit may include one or more electrical connection features to enable electrical connectivity between the unit and an add-on unit. The unit may also include one or more structural connection features which may enable connection of an add-on unit to the primary unit, which may also be referred to as a starter unit. Structural connection features may be screw holes, screws, bolts, metal, plastic, or hybrid barbs, studs, prongs, snap-fits, press-fits, clips, or other means of connection known in the art.

The starter unit may be configured to receive or otherwise connect to a clip-on module or other type of secondary module. The starter unit may include one or more connection features to enable connection to the secondary module, such as snap fits, openings, screw holes, studs, clips, hooks, or surfaces configured to enable a press-fit. The one or more features may be proximal to a first side of the starter unit, such as a front face, or may be located along an internal or external edge or surface. In one embodiment, the secondary module may include male snap-fit features which may connect to female snap-fit features within or on the starter unit. In a preferred embodiment, the secondary module may be removably connectable to the starter unit.

The secondary module may be connectable to the starter unit so as to enable electrical connectivity between the secondary module and the starter unit. In one embodiment, one or more electrical connection features of the starter unit are configured to receive prongs which may extend at least partially from the secondary unit.

The system may include a wire guard, which may be integral with the starter unit or may be connectable to it. The starter unit may also include a wire manager feature or component, such as components or features which may extend from the starter unit or create pathways along at least one surface of the starter unit so as to guide, group, or otherwise segregate wires.

The unit may be part of a system, which may include a starter unit and at least one add-on unit. The starter unit may connect to the wiring of a structure, and include at least one electrical or wired pathway which may extend to the add-on unit or connectors of the add-on unit. The system may also include an intermediate connector, such that the starter unit and the add-on unit may not connect directly, but may be connected by means of an intermediate connector. In one embodiment, the add-on unit may connect to the starter unit by means of features such as electrical prongs which may extend or be extendable from the add-on unit to the starter unit, or vice versa. In another embodiment, neither the starter unit nor the add-on unit may include proud connector features. In such an embodiment, the starter unit and the add-on unit may have female connection ports, while the intermediate connector may include male connection features, such as prongs, for connection to both the starter unit and the add-on unit. In such an embodiment, the starter unit and add-on unit may be very similar or may be identical. In another embodiment, the two units may still be similar or may be identical, with prongs being removable, collapsible, foldable, or coverable by additional components or features when not desirable to be exposed or in use.

The starter unit and add-on unit may be directly connectable structurally, such as through screw holes and screws or snap-fits, or may connect through intermediate components. Each unit may be connected to a structure, such as to studs or beams, or only one unit, such as the starter unit, may be connected to and supported by the structure, while the add-on unit is connected to and supported by the starter unit.

The starter unit may include electrical junctions or pathways enabling connection to a modular face unit, to an add-on unit, or both. The pathways may be separate or may be at least partially connected, such as through the use of a bus bar (also known as a “buss bar”, “busbar”, “bus-bar”, and various other terms which will be understood by those with knowledge of the art).

The starter unit may include one or more connection features for connection to a modular face unit. A modular face unit may connect to the starter unit by means of a press-fit, screws or bolts, prongs, studs, one or more snap-fits and related features, or through other means known in the art. In a preferred embodiment, the modular face unit may be removably connectable to the starter unit.

The modular face unit may include one or more electrical connection features for connecting through the starter unit to the wiring of the structure, either directly or indirectly. In one embodiment, the modular face unit includes prongs which extend from the modular face unit into features, such as openings, in the starter unit which are configured to receive the prongs. The prongs may be at least partially retained by electrical junction elements, such as springs, though they may also be configured to make contact with the electrical pathways of the starter unit while being retained in place by the connection of the modular face unit to the starter unit.

The unit may also be configured, such as through the use of the clip holes or other clip or connection features, to receive a clip-on module. The clip-on module may attach to the unit from a single direction, such as sliding into and connecting with the unit from the front. The unit may include one or more access holes. The access holes may be configured to connect to wiring, one or more bus bars, or other known elements from a rear or side of the unit. The access holes may be through-holes, passing from a first surface of the unit to a second surface, such as allowing access from the front of the unit to wiring or electrical connectors at or proximal to the rear of the unit. The access holes may also, or alternatively, include electrical connection features, such as wiring, bus bars, springs, or other elements known in the art, which may be further connected to electrical elements without necessitating a direct pass-through from the first surface of the unit to a second surface of the unit. The access holes may also or alternatively include elements, such as leaf springs, coil springs, or other means known in the art, for retaining wiring or electrical connections. In one embodiment, a clip-on module may include electrical connection prongs. The unit may be configured to receive one or more of the prongs through one or more access holes. The access holes may retain electrical wiring or connections, such as from the rear of the unit, thus creating an electrical connection to the prongs. Additionally, or alternatively, the prongs may be retained within the access holes when a clip-on module is attached to the unit. The features of or within the access holes may retain the prongs and thus retain the clip-on unit, the clip-on unit may be snap-fit, screwed in, or otherwise attached to the unit, thus locating and retaining the prongs within the access holes, or both.

In one method of use of some of the embodiments of the present disclosure, one or more units may be mounted to a structure, such as a building, during construction. A user, such as an electrician, may prepare one or more locations for later electrical connection by mounting units and connecting them to the wiring of the building prior to completion of the building. In such a way, what is generally a very time-consuming portion of a construction may be done early in a project. Full connections may be later planned out or modified, or decisions may be made as to the types of utilities, appliances, outlets, face plates, customization, or other details of a construction. Drywall or other construction may be assembled surrounding, proximal to, or partially covering the units. At another stage of the construction, the electrician or other user may return and connect the desired clip-on modules to the units without requiring complicated, time-consuming, or expensive electrical work. In another, or subsequent, method of use, changes may be made to clip-on modules after initial assembly. In one optional scenario, renovations or repairs may be enacted on, proximal to, or surrounding a unit. The clip-on, or otherwise attached, module may be removed without requiring removal of drywall, rewiring, or other expensive work. A replacement or alternate clip-on module may be connected to the unit.

In another method of use, a user may install one or more starter units and, optionally, add-on units. The user may install snap-in modules to one or more of the units and, in one method of use, may cover them by material or one or more cover components (not shown), which may further optionally be configured to removably snap-in, be screwed in, adhered in position, attached using a hinge mechanism, or otherwise provide protection to the installed units, such as from dust or debris, while enabling later connection of additional components. A protective component may be removable from, separable from, rotatably connected to, slidably connected to, or unitary with the unit which it protects.

The unit may also include a wire guard. The wire guard may be removably or permanently attached to the unit, such as by means of one or more snap-fit features. The wire guard may be configured to retain wiring or other electrical elements in place, aid in preventing them from contacting other objects or structures, or allow for exposed electrical connections or wiring while reducing the risk of undesired contact or shorting. The wire guard may be made of metal, such as steel or aluminum, plastic, or may be made of any material which may provide sufficient protection and/or support to at least partially retain electrical wiring in a desirable area or prevent unintended contact with the electrical wiring. The wire guard is shown as connectable to the rear of the unit, though it should be understood that it may connect to other surfaces or features of the unit, may be a feature of the unit itself, may be one or two or more similar elements, or may be omitted. The unit may also include one or more wire managers, which may be separate components or may be part of the unit itself, such as a unitary feature of the unit. The wire managers may be configured to receive one or more wires or other electrical elements, grouping or directing them so as to organize wiring or otherwise direct electrical elements. Wire managers may be substantially open on multiple sides, such as the top, bottom, sides, or partially or substantially along the back. Wire managers may also be substantially enclosed, including up to on five sides, such as having a substantial wall along the back, sides, bottom, or top, up to enabling only access for wires and otherwise protecting the wires, connections, and interfaces.

The unit may include one or more sheetrock guides or other elements or features to aid in mounting the unit or to aid in mounting materials against or proximal to the unit. The guide may also be configured as a stop or prevent materials, such as sheetrock, from being mounted too far relative to the unit.

The unit may be optionally configured to be attached to or to allow attachment of additional units or other elements, such as switches or outlets. The unit may include one or more connection features, such as threaded holes, for threaded attachment of add-on boxes, such as to the top, bottom, or side of the unit. Other connection means, such as snap-fits or bolts, may also be used without deviating from the intent of the disclosure. The unit may also include one or more electrical access openings, such as for connection or insertion of electrical features such as prongs from an add-on boxes. The unit may be wired to an electrical connection, such as at the back, top, or bottom of the unit, and an add-on box may be attached to the unit, such as from the side, top, or bottom of the unit. In such a way, a single unit may be wired to a structure, and it may include electrical routing to allow a second unit to connect through the first unit, without requiring that the second unit have direct wiring to the structure.

In one embodiment, the unit includes one or more holes for connection of wiring through the back of the unit, such as for allowing connectivity with a three-way switch. The unit may include insertion holes for live current, ground wires, common lines, or other electrical wiring and connection means known in the art. A single opening may be used for one or more of the electrical lines described, which may optionally be extended to multiple connections through the unit, such as by means of a bus bar, or multiple openings for multiples lines may be present. The unit may further be configured to manage wires while separating them using a wire manager, or wiring may be grouped together. In one embodiment, separate lines of wiring may be separated by wire manager features, allowing simplified and more easily mapped wiring. Each grouping may then connect through the unit through separate groupings of one or more access holes. A single wire guard may optionally be attached to the unit, covering up some or all of the wire manager, or multiple, smaller, or discrete wire guards may be attached to the unit or to the wire manager or separate wire managers.

An optional add-on unit may include prongs or other means of electrical connection which may be configured to be received by the unit so as to allow linking of two or more units without requiring wiring each individual unit to the structure. An add-on unit may include such features, and may also include additional access openings or connection features to enable connection of subsequent additional add-on units. The main unit may also optionally include prongs or other connection means, allowing any unit to be used as a main unit or as an add-on unit. The prongs or connections features may optionally be removable, such as where an add-on unit is being used or installed as a main unit, or may be foldable or configured to receive a cover element (not shown), such as to prevent exposure of the features or to save space when an add-on unit is being used as a main unit. The main unit may be a starter module, configured to be connected or wired to the structure, with add-on units connecting or connectable to the start unit, or some or all units may be interchangeable.

In other embodiments, the prongs or other connection features, such as an intermediate connector component, may be made of a non-electrically-conductive material, may be at least partially coated in an electrical insulator, may be sufficiently short or thin as to not create an electrical pathway, or may otherwise not enable electrical transmission from the starter-unit to an add-on unit. In such embodiments, the connection between a starter unit and an add-on unit, or between multiple add-on units, may create a point of structural connection or may function to block or otherwise protect electrical connections or openings in one or more units, while still allowing for the one or more add-on units to be connected to a separate electrical circuit than that of an adjacent or proximal unit. Such embodiments may also aid a user in correctly installing additional materials, such as sheetrock, adjacent to, in contact with, or proximal to one or more units, in addition to optimizing available space for locating electrical connection points, while allowing for separate electrical circuits. Similarly, an add-on unit may connect to an electrical pathway in an adjacent or proximal starter unit or second add-on unit, while internal electrical pathways within the add-on unit may be separate and distinct, thus allowing for some electrical transmission between adjacent or proximal units, while also allowing for separate electrical circuits within and connected to such units.

The unit may be part of a system which may include a clip-on face, such as a duplex outlet. The outlet may include two electrical connections, though it may include only one connection or may include more connections. It may also include no connections, such as when the clip-on face is intended for an electrical switch or dial. The clip-on face may include one or more prongs, such as on a rear surface of the clip-on face, which may be configured to be received by or otherwise connect to or interface with the unit, such as through access holes or other connection features of the unit. The clip-on face may clip into or onto the unit, such as through clip-on holes, may be retained by the unit by means of the prongs, or may be connected through other means known in the art, such as press-fits, screws, or bolts. In the embodiment shown, the clip-on face includes male clips which may be received by female clip slots in the unit, retaining the clip-on face within or against the unit. In one embodiment, the clips are configured to retain the clip-on face against the unit, but to release when sufficient force is applied to the clip-on face, or when a release mechanism is triggered, or when a release tool, such as a flat-head screw driver, is inserted into or against the clip feature. The clip features may be configured such that one or more prongs of the clip-on faces are received by or guided by access openings in the unit prior to fully seating the male clip features within the clip openings of the unit.

The clip-on face may include one or more screw holes for resiliently mounting the clip-on face to the unit. The clip-on face may also include one or more screw holes for mounting a face plate to the clip-on face, though it should be understood that other connection means, such as already described within this disclosure or otherwise known in the art, may also or alternatively be used. A face plate may optionally be attached to the clip-on face. The face plate may be replaceable or readily swappable. In one method of use, a starter unit may be wired into the structure. When construction or renovation on the structure has progressed, such as after drywall work on the structure, a clip-on face may be inserted into or attached to the starter unit. The structure and surfaces, such as the drywall, may then be painted, wall papered, or otherwise finished. Once such work is completed or otherwise advanced, a face plate may then be attached to the clip-on face, or through it to the starter unit. Such a method of use may allow for leaving the cosmetic components to be installed under after the work that is most likely to dirty or damage them has been completed. It may also allow for near-completion of a structure prior to allowing a purchaser to customize the face plates which they desire for the structure. It may also allow for swapping face plates to match renovations or painting of portions of the structure without requiring removing or replacing substantial electrical components and wiring.

The unit may be configured to receive a variety of different types of clip-on faces and types of electrical connections. The starter unit may be configured to have multiple electrical connections or wiring openings, such as for a single outlet, a duplex outlet, a two-sway switch, a three-way switch, or other configurations which may be desirable to a user. In one embodiment of the clip-on face configured to enable a three-way switch to be used with the unit. The clip-on face may include multiple prongs which may be received by the starter unit, and may allow for direct electrical connection or the use of a switch, which may be included in the clip-on face or may be part of a separate face plate. A clip-on face configured for a split outlet may also be used. Separate wiring and connectors may be used in these and other plates, faces, and units, or combinations of wiring and features such as bus bars may be used. It should be understood that other types of electrical outlets, switches, and connections may be used, or the unit may be modified to receive such features or connections, without deviating from the intent or scope of this disclosure. The starter unit enables modularity and modification of electrical connections and supply such that a single unit, or multiple add-on units, may be installed, with later or subsequent installation of additional add-on units, clip-on faces, and face plates, as well as subsequent modification or replacement of such components, while minimizing or eliminating the need for rewiring, removal, or modification of the base unit.

It should be understood that the unit, add-on components, and associated system and method of use apply to a range of other devices and features where electrical conductivity or supply may be desirable or necessary. In one embodiment, the device and system of the present disclosure is shown in an embodiment which enables connection of lighting elements, such as for lighting fixtures which may be mounted to a wall or ceiling. The unit may be circular, or any other desirable shape, though such shape may be part of the frame itself or may be a cover feature which may be part of the main unit or may be attachable to it, either removably or permanently. The main unit may be circular, or it may be another shape, such as rectangular, and the clip-on face may be circular or have a circular exposed surface or features. The main unit or the clip-on face may include one or more connection features for attachment of a light fixture, such as clips for snap-fitting a lighting fixture or to allow rotational alignment and retention of a lighting fixture. Separate, connectable, or removably connectable lighting fixtures may be configured to be received by the main unit or by the clip-on face, which may be present or may be absent. In one embodiment, a light fixture may attach directly to the main unit, such as by insertion into or onto the main unit and retention by snap-fit features or screws. A light bulb, LED, or other light source may then attach or be attachable to the light fixture. In another embodiment, a clip-on face may attach to the main unit, as has already been described, and a light fixture may then attach or be attachable to the clip-on face, either slidably or rotatably.

It should be understood that any type of device may be connectable to or through the unit, particularly where electrical connectivity and supply are desirable. Other types of components which may be used without deviating from the intent or scope of this disclosure include, but are not limited to, ceiling fans, security cameras, and monitors.

In one method of use, a user, such as an electrical contractor, may install a starter unit in a structure. The starter unit may be attached to a stud, beam, wall, ceiling, or other element of the structure. The user may optionally connect an add-on unit to the starter unit. Multiple starter units and/or add-on units may be installed within a structure. Work may progress on building or renovating the structure, and then a user may connect one or more modular secondary units to the starter unit and/or to the optional add-on units. When work reaches a desired stage on the structure, a user may then install one or more face plates onto the one or more starter units, optional add-on units, or modular secondary units. Other systems or components may also be installed instead of or in addition to the face plates or modular secondary units. Such components may include light fixtures, fans, security cameras, monitors, fire or other alarms or sensors, or any other items or components which may be desirable, and particularly such components or items which may require or benefit from electrical connectivity or connectivity to other lines, such as cable or telephone.

The method may include the use of a device which may include one or more of the features, steps, or components described herein. Any number of steps or elements may be used in conjunction with the method described, and various means for connections, support, electrical or signal connectivity or transfer, and protection may be incorporated.

It is to be understood that the above-mentioned steps and features and the steps and features yet to be explained hereinafter can be used not only in the respectively mentioned combinations but also in other combinations or alone, or in other orders, without departing from the context of the present invention.

### BRIEF DESCRIPTION OF THE DRAWINGS

The invention is now disclosed in detail with reference to exemplary embodiments shown in the accompanying drawings, where:

FIG. 1 shows a front right isometric view of an embodiment of the starter module of the modular electrical connector unit of the present disclosure;

FIG. 2 shows a front left isometric view of the embodiment of the starter module of the modular electrical connector unit of FIG. 1;

FIG. 3 shows a front view of the embodiment of the starter module of the modular electrical connector unit of FIG. 1;

FIG. 4 shows a right side view of the embodiment of the starter module of the modular electrical connector unit of FIG. 1;

FIG. 5 shows a top view of the embodiment of the starter module of the modular electrical connector unit of FIG. 1;

FIG. 6 shows a back view of the embodiment of the starter module of the modular electrical connector unit of FIG. 1;

FIG. 7 shows a front cross-sectional view of the embodiment of the starter module of the modular electrical connector unit of FIG. 1;

FIG. 8 shows another front cross-sectional view of the embodiment of the starter module of the modular electrical connector unit of FIG. 1;

FIG. 9 shows a front right isometric view of an embodiment of the add-on module of the modular electrical connector unit of the present disclosure;

FIG. 10 shows a front left isometric view of the embodiment of the add-on module of the modular electrical connector unit of FIG. 9;

FIG. 11 shows a front right isometric view of an embodiment of the clip-on module of the modular electrical connector unit of the present disclosure;

FIG. 12 shows a back left isometric view of the embodiment of the clip-on module of the modular electrical connector unit of FIG. 11;

FIG. 13 shows a front view of the embodiment of the clip-on module of the modular electrical connector unit of FIG. 11;

FIG. 14 shows a right side view of the embodiment of the clip-on module of the modular electrical connector unit of FIG. 11;

FIG. 15 shows a back view of the embodiment of the clip-on module of the modular electrical connector unit of FIG. 11;

FIG. 16 shows a front right isometric view of an embodiment of the wire manager module of the modular electrical connector unit of the present disclosure;

FIG. 17 shows a right side view of the embodiment of the wire manager module of the modular electrical connector unit of FIG. 16;

FIG. 18 shows a front view of the embodiment of the wire manager module of the modular electrical connector unit of FIG. 16;

FIG. 19 shows a front right isometric view of an embodiment of the modular electrical connector unit of the present disclosure;

FIG. 20 shows a front view of the embodiment of the modular electrical connector unit of FIG. 19;

FIG. 21 shows a right side view of the embodiment of the modular electrical connector unit of FIG. 19;

FIG. 22 shows a top view of the embodiment of the modular electrical connector unit of FIG. 19;

FIG. 23 shows a front left isometric view of another embodiment of the starter module of the modular electrical connector unit of the present disclosure, without an optional flange component;

FIG. 24 shows a front right isometric view of an embodiment of the optional flange component of the modular electrical connector unit of the present disclosure;

FIG. 25 shows a front right isometric view of the embodiment of the starter module of the modular electrical connector unit of FIG. 23 with the optional flange component of FIG. 24;

FIG. 26 shows a front left isometric view of the embodiment of the starter module of the modular electrical connector unit of FIG. 23 with the optional flange component of FIG. 24;

FIG. 27 shows a front right isometric view of another embodiment of the wire manager module of the modular electrical connector unit of the present disclosure;

FIG. 28 shows a front right isometric view of another embodiment of the add-on module of the modular electrical connector unit of the present disclosure;

FIG. 29 30 shows a right side view of the embodiment of the add-on module of the modular electrical connector unit of FIG. 28;

FIG. 30 shows a front right isometric view of the front component of the embodiment of the add-on module of the modular electrical connector unit of FIG. 28;

FIG. 31 shows a back left isometric view of the front component of the embodiment of the add-on module of the modular electrical connector unit of FIG. 28;

FIG. 32 shows a front right isometric view of the back component of the embodiment of the add-on module of the modular electrical connector unit of FIG. 28;

FIG. 33 shows a back left isometric view of the back component of the embodiment of the add-on module of the modular electrical connector unit of FIG. 28;

FIG. 34 shows a front right isometric view of the middle component of the embodiment of the add-on module of the modular electrical connector unit of FIG. 28;

FIG. 35 shows a back left isometric view of the middle component of the embodiment of the add-on module of the modular electrical connector unit of FIG. 28;

FIG. 36 shows a front view of the middle component of the embodiment of the add-on module of the modular electrical connector unit of FIG. 28;

FIG. 37 shows a right side view of the middle component of the embodiment of the add-on module of the modular electrical connector unit of FIG. 28;

FIG. 38 shows a back view of the middle component of the embodiment of the add-on module of the modular electrical connector unit of FIG. 28;

FIG. 39 shows a back left isometric view of another embodiment of the clip-on module of the modular electrical connector unit of the present disclosure;

FIG. 40 shows a right side view of the embodiment of the clip-on module of the modular electrical connector unit of FIG. 39;

FIG. 41 shows a front right exploded isometric view of the embodiment of the clip-on module of the modular electrical connector unit of FIG. 39;

FIG. 42 shows a front right isometric view of the front component of the embodiment of the clip-on module of the modular electrical connector unit of FIG. 39;

FIG. 43 shows a back right isometric view of the front component of the embodiment of the clip-on module of the modular electrical connector unit of FIG. 39;

FIG. 44 shows a right side view of the front component of the embodiment of the clip-on module of the modular electrical connector unit of FIG. 39;

FIG. 45 shows a top view of the front component of the embodiment of the clip-on module of the modular electrical connector unit of FIG. 39;

FIG. 46 shows a front right isometric view of the back component of the embodiment of the clip-on module of the modular electrical connector unit of FIG. 39;

FIG. 47 shows a back left isometric view of the back component of the embodiment of the clip-on module of the modular electrical connector unit of FIG. 39;

FIG. 48 shows a front view of the back component of the embodiment of the clip-on module of the modular electrical connector unit of FIG. 39;

FIG. 49 shows a back view of the back component of the embodiment of the clip-on module of the modular electrical connector unit of FIG. 39;

FIG. 50 shows a front right isometric view of an embodiment of the ground buss bar of the embodiment of the clip-on module of the modular electrical connector unit of FIG. 39;

FIG. 51 shows a front right isometric view of an embodiment of a switch buss bar for an embodiment of the clip-on module of the modular electrical connector unit of the present disclosure;

FIG. 52 shows a front left exploded isometric view of an embodiment of the add-on module of the modular electrical connector unit of the present disclosure;

FIG. 53 shows a back left exploded isometric view of the embodiment of the add-on module of the modular electrical connector unit of FIG. 52;

FIG. 54 shows a front right isometric view of an alternate embodiment of the add-on module of the modular electrical connector unit of the present disclosure, including an embodiment of an optional adjustable flange;

FIG. 55 shows a front view of the embodiment of the add-on module of the modular electrical connector unit of FIG. 54, including an embodiment of an optional adjustable flange;

FIG. 56 shows a top view of the embodiment of the add-on module of the modular electrical connector unit of FIG. 54, including an embodiment of an optional adjustable flange;

FIG. 57 shows a front right isometric view of an alternate embodiment of a starter module of the modular electrical connector unit of the present disclosure, including a mounting bracket;

FIG. 58 shows a front right isometric view of the embodiment of the starter module and mounting bracket of the modular connector unit of FIG. 57 in an unassembled configuration without a wire manager component;

FIG. 59 shows a front right isometric exploded view of an embodiment of the starter module, clip-on module, and mounting bracket of the modular electrical connector unit of the present disclosure;

FIG. 60 shows a front right isometric view of an alternate embodiment of the starter module, add-on module, and mounting bracket of the modular electrical connector unit of the present disclosure in a partially assembled configuration;

FIG. 61 shows a front right isometric view of an embodiment of the add-on module of the modular electrical connector unit of the present disclosure in an unassembled configuration;

FIG. 62 shows a front right isometric view of an alternate embodiment of the start module of the modular electrical connector unit of the present disclosure with an alternate embodiment of a mounting bracket; and

FIG. 63 shows an embodiment of a buss bar of the modular electrical unit of the present disclosure.

### DETAILED DESCRIPTION

Exemplary embodiments of the disclosure are illustrated in the Figures and are explained in the following description in more detail, wherein identical or similar reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, steps, and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form, or merely described textually or implied to those skilled in the art, in order to facilitate describing the disclosed subject matter.

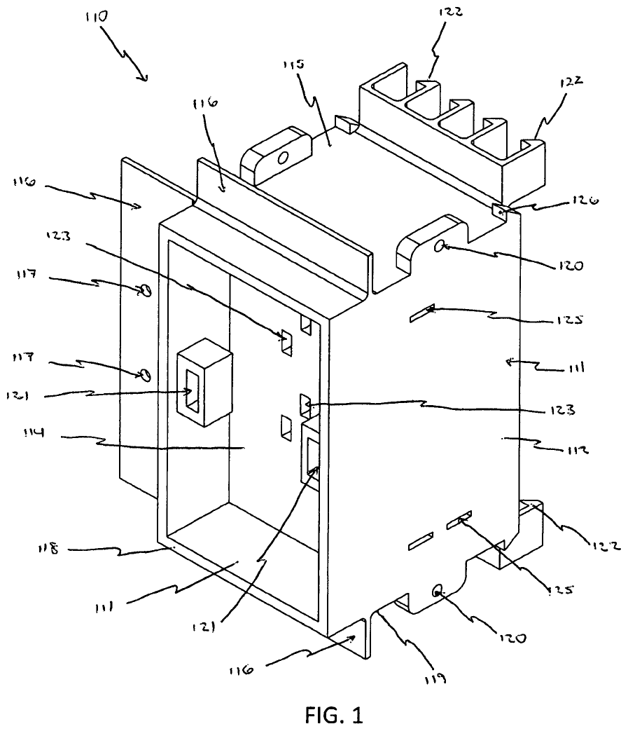

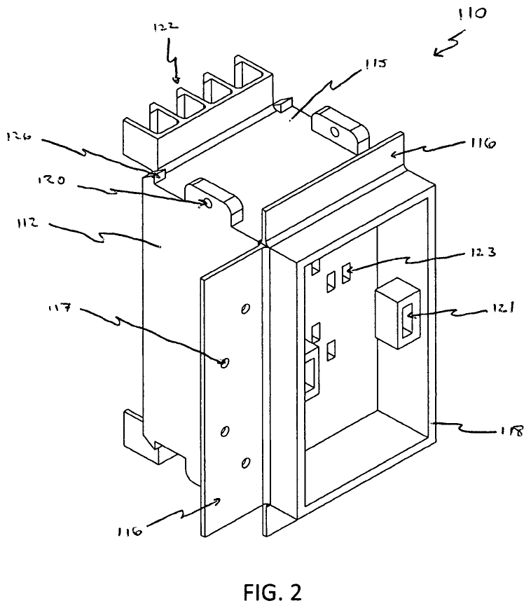

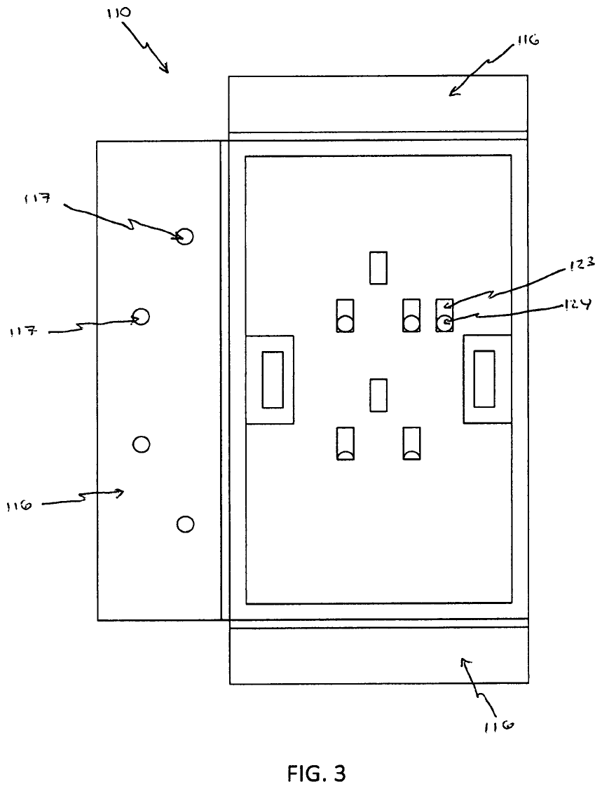

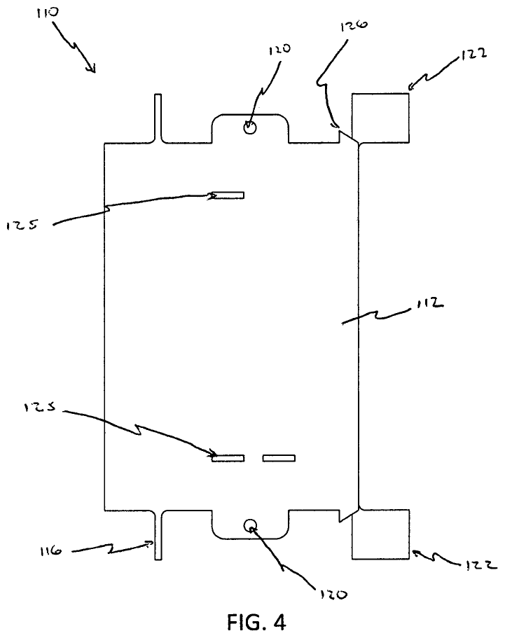

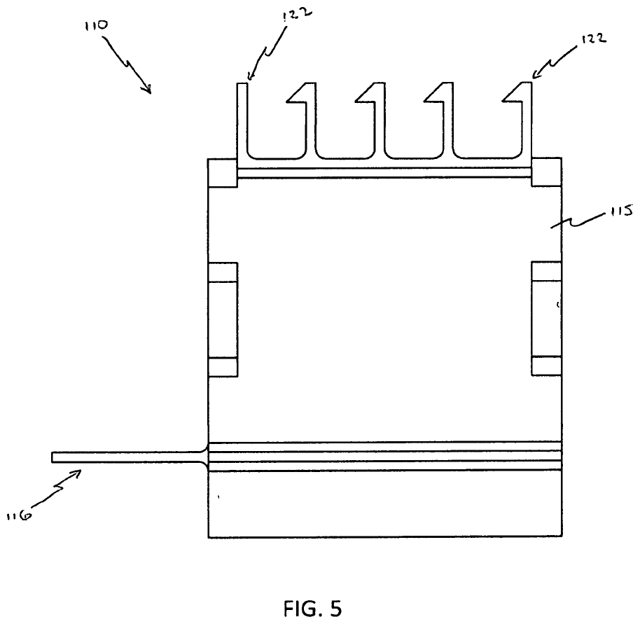

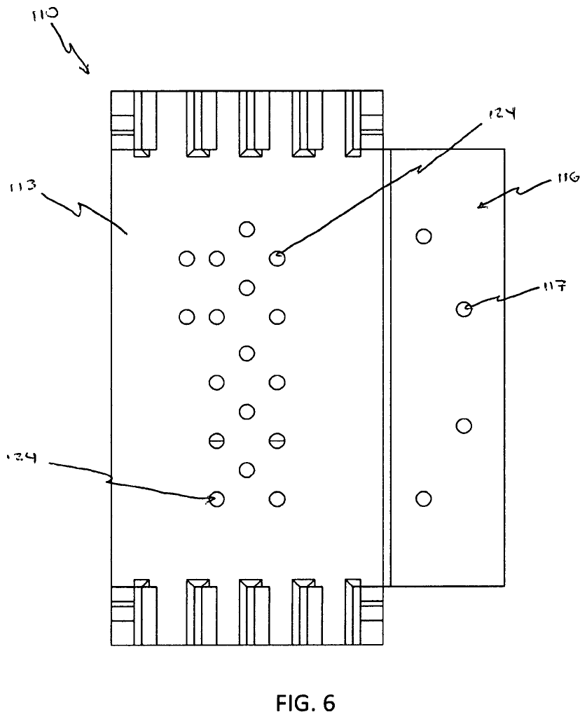

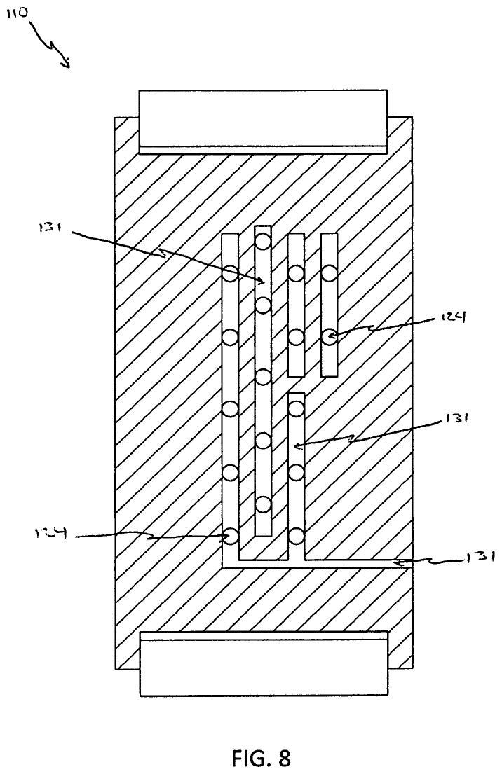

FIGS. 1-8 show an embodiment of a starter module 110 of the modular electrical connector unit 100 of the present disclosure. The starter module 110 may include a frame 111 or other structural or support element which may be configured to retain some or all of the other components of the starter module 110 or the unit 100, may be configured for mounting, attachment, or support of components or one or more additional units 140, or may facilitate mounting, support, or connection of the module 110 relative to other devices or structures, such as walls, ceilings, or floor studs, beams, or joists. Though the frame 111, as shown in FIG. 1, is depicted as substantially rectangular, it should be understood that other shapes may also be used, such as squares, circles, ellipses, trapezoids, hexagons, octagons, irregular shapes, composite shapes, and other shapes, without deviating from the intent of the disclosure. The frame 111 may further include one or more sides 112, may include a back 113 or back plate 113, may include a front or front plate 114, may include a top 115, may include a back 113, or may include any combination of such features or omit one or more of such structures or components. The frame 111 may be unitary, such as a molded, machined, bent, folded, or welded part, or may be constructed from two or more other components, which may be connected directly to each other, such as through welding, sintering, screwing, bolting, snap-fits, or other means known in the art, or which may not be connected directly to each other. The frame 111 may be made entirely or partially out of a substantially rigid material, such as steel, aluminum, or plastic, or may be made to be deformable during manufacture or installation. The frame 111 may be plastically or elastically deformable, or may be flexible, such as for conditions or environments where flexibility may be desirable or advantageous. The frame 111 may be made of any material with sufficient strength to retain components and features which may be attached to the frame 111 during use, though in many preferable uses it may be desirable for the frame 111 to be made of a rigid material which may protect electrical components and features and offer structural support allowing connectivity of the frame 111 to elements such as studs, beams, joists, walls, and other similar elements. The frame 111 may be electrically conductive, though it may also be an insulator or may be at least partially coated or covered with an insulating material, or may be configured to retain insulating material. In a number of embodiments, the frame 111 is made of a material such as steel or aluminum, which may be conductive, but may include insulating materials or components to prevent conduction of electricity from attached electrical wiring to a user who may be installing, replacing, or modifying the frame 111, or connecting additional components or other units 140 to the frame 111.

The starter module 110 may include one or more support connection features 116 or surfaces, such as a mounting flange 116 and/or one or more holes 117 or attachment guides. A mounting flange 116 may be configured to aid in mounting the module 110 against or at least partially flush with a support structure, such as a stud, beam, joist, or other structure or surface. The module 110 may be connected to a support feature or structure, such as by screwing the unit to a stud through one or more holes 117. Connection features 116, such as flanges 116, may be offset at different depths or distances from other surfaces of features of the module 110, such as relative to the front 118, back 113, top 115, bottom 119, or side surfaces 112. Multiple depths or distances may be used for different modules 110, for different features or flanges 116, or a feature or flange 116 may be an irregular shape which may allow for fitting against different surfaces or at different depths or lengths. One or more flanges 116 may also be flexible, plastically or elastically deformable, removable, scored or selectively thinned so as to allow removal, or contain one or more deformable, removable, or cut-able components, surfaces, or features, such as where a flange 116, or a portion of a flange 116, may be bent or removed to allow for use at a greater or lesser offset. In one embodiment, a flange 116 may be offset ½″ from a surface 118 so as to allow for sheetrock. In another embodiment, a flange 116 may be offset ⅝″. It should be understood that other offsets, such as ¼″, ¾″, 1″, and others lesser, in between, or greater than these amounts may also be used without deviating from the scope or intent of this disclosure.

The starter module 110 may include one or more attachment features 121 such as clip connectors, clip holes, or other holes 121, which may be threaded or may not be threaded. One or more surface elements, such as face plates 170, may be clipped, snap-fit, screwed on, or otherwise attached to the module 110 by means of the clip features 121. The module 110 may also include clip features or other attachment features, such as holes 120, whether threaded or not, which may be configured to receive additional modules 110, other types of modules 140, or connection elements for connecting and/or mounting additional units 140 to the module 110. Additional units 140, or face or surface plates 170, may also connect to the module 110 by means of light press-fits, screws, bolts, or snap- or snap-like features which may connect to other features of the unit 110.

The starter module 110 may include one or more wire retention features 122. The wire retention features 122 may be located on the back 113 of the starter module 110, or on or proximal to any surface, such as the top 115 or bottom 119, where wire retention may be desirable or beneficial. One or more wires may be passed along or into the starter module 110, or proximal to the starter module 110, and the wire retention features 122 may aid in managing the wires during installation or other wiring work, or simply to aid in organizing or segregating the wires. In one embodiment, the wire retention features 122 are shaped like partial barbs, extending away from the back 113 of the starter module 110, so as to aid in retaining wires while also separating them, such as separating a ground wire from a positive wire, while also allowing for easy insertion of one or more wires into the starter module 110 or to allow for easy routing along its back 113.

The starter module 110 may include one or more openings or ports 123 to enable access to wires, buss bars 130, or other electrical connectivity within the starter module 110. In the embodiment shown, multiple ports 123 are depicting on the front inner surface 114 of the starter module 110, such as for connection from a clip-on module 140 to internal buss bars 130, though it should be understood that ports 123 or other electrical connectivity features may be located on other surfaces or features of the starter module 110.

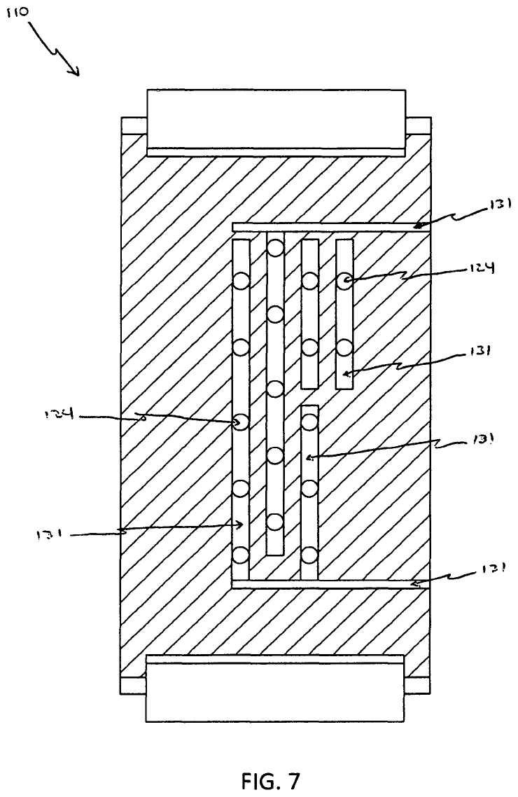

Though various difference means of electrical or other signal transfer may be used without deviating from the scope of this disclosure, in one embodiment the starter module 110 include one or more buss bars 130 within the body of the frame 111. The buss bars 130 may conduct electricity or signals from one connection point, such as a rear wire opening 124, to another point, such as a connection port 123. As can be seen in cross-sectional views in FIGS. 7 & 8, the starter module 110 may include one or more channels 131 configured to receive one or more buss bars 130. The channels 131 may substantially surround the buss bars 130, and may be configured to match the shape of the buss bars 130, or allow offset space on one or more sides of the buss bar 130, such as where the buss bar 130 may be shaped so as to enable better connection with an inserter wire or prong or where it may be necessary to include insulating material around some or all of a buss bar 130.

The starter module 110 may include one or more add-on ports 125 for conducting electricity or signals between the starter module 110 and additional units 140, such as another starter module 110 or an add-on module 140. In such a way, and by way of example, a single ground line to a starter module 110 could be connected, such as by means of buss bars 130, to ground connections in a clip-on module 170 as well as to one or more add-on modules 140.

One or more wires, such as for a ground line, a positive line, and a negative line, may be connected to the starter module 110 through openings 124 or other attachment features, such as on the back 113 of the starter module 110. In one embodiment, the one or more wires are retained within the starter module 110, after passing through the openings 124, by means or spring clips which are internal to the starter module 110, though it should be understood that other means of wire retention may also be used without deviating from the scope or intent of this disclosure.

The starter module 110 may also include one or more retention features 126 to aid in attachment and retention of additional components, such as a wire manager 190. In the embodiment shown, the wire manager retention features 126 are configured to enable clipping of the wire manager 190 onto the starter module 110, or to prevent movement in a specified direction after the wire manager 190 is optionally slid onto the starter module 110.

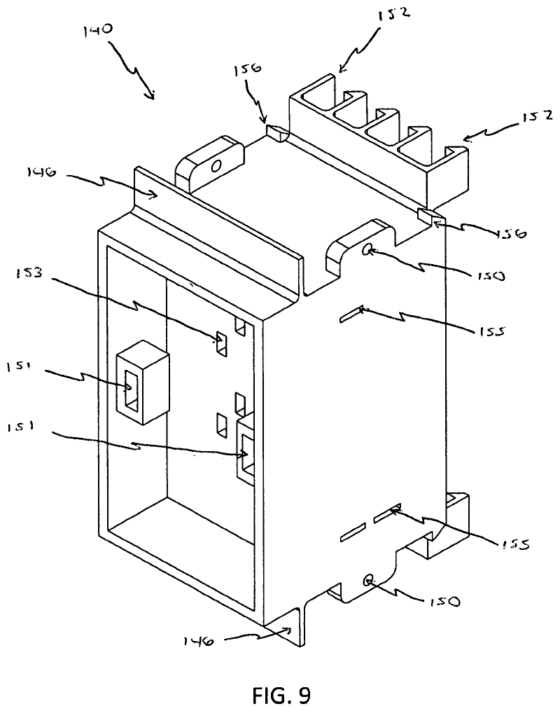

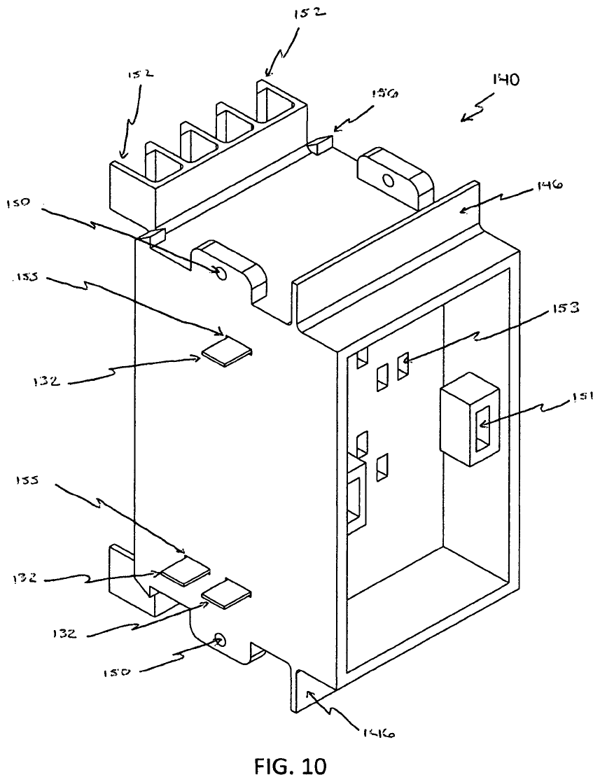

An embodiment of an add-on module 140 is shown in FIGS. 9-10. The add-on module 140 may be configured to be optionally attachable to a starter module 110 or to other components, such as other add-on modules 140. The add-on module 140 may also be configured to enable attachment of additional components, such as one or more clip-on modules 170. The add-on module 140 may include one or more features which are substantially similar to those of the starter-module 110 previously described, such as an add-on module flange 146. In the embodiment shown, the add-on module 140 includes two flanges 146 for support against drywall or sheetrock, though it does not include a mounting flange 116, as the embodiment shown has the add-on module 140 retained by the starter module 110. It should be understood that other combinations and arrangements of flanges 146 may also be used, as well as no flanges 146 whatsoever, without deviating from the scope or intent of this disclosure.

The add-on module 140 may also optionally include other features which are similar to those of the starter module 110, such as one or more channels (not shown) for buss bars 130, one or more wire retention features 152, one or more wire manager retention features 156, which may be optionally used with a wire manager 190, attachment features 150 for connection to a starter module 110 or to another add-on module 140, or both, attachment features 151 for attachment to other components such as one or more clip-on modules 170, wire ports (not shown) similar to those on a starter module 110, though these may also be entirely absent on an add-on module 140, ports 153 for connection of electrical or signal elements such as from a clip-one module 170, and ports 155 for connection to buss bars 130 or other internal conductive elements from a starter module 110 or other add-on module 140. A prong or wire may extend from one or more of the ports 155 on the add-on module 140 or similarly from one or more of the ports 125 on the starter module 110 in order to enable connectivity between them, or the wire or prong may be a separate attachable component. As shown in FIG. 10, one or more prongs 132 which are features or extensions of one or more buss bars 130 may extend between the add-on module 140 and the starter module 110.

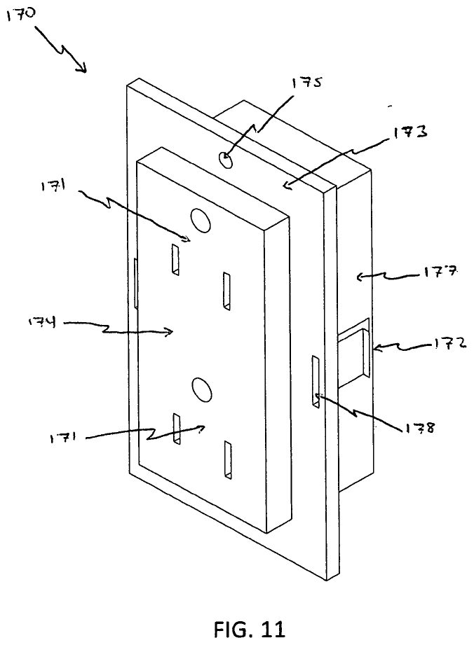

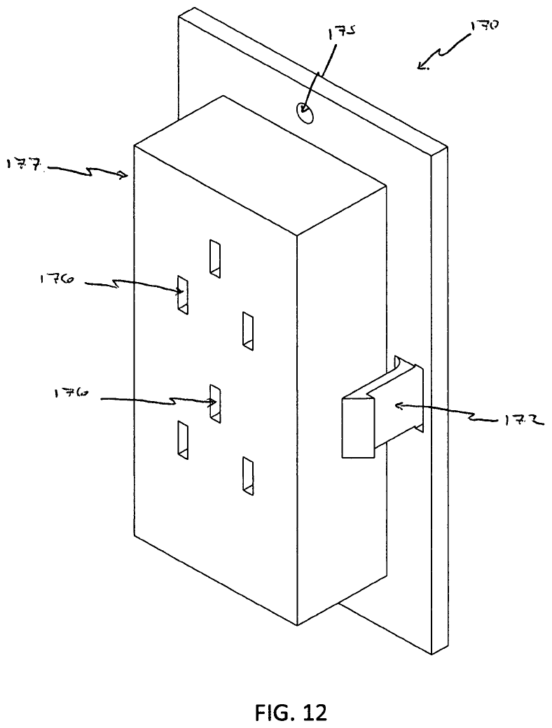

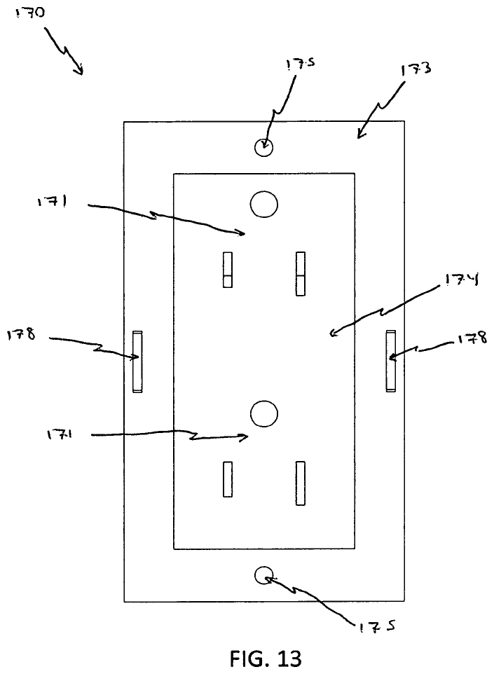

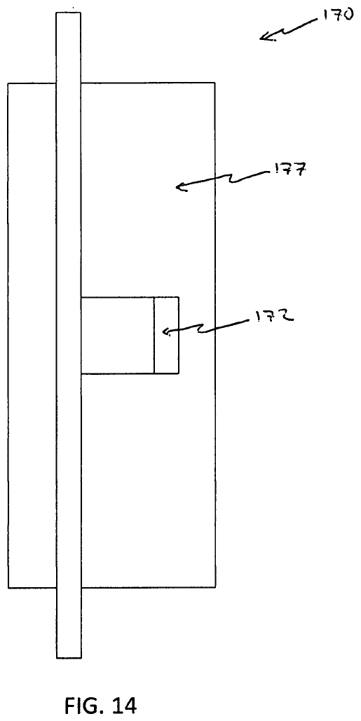

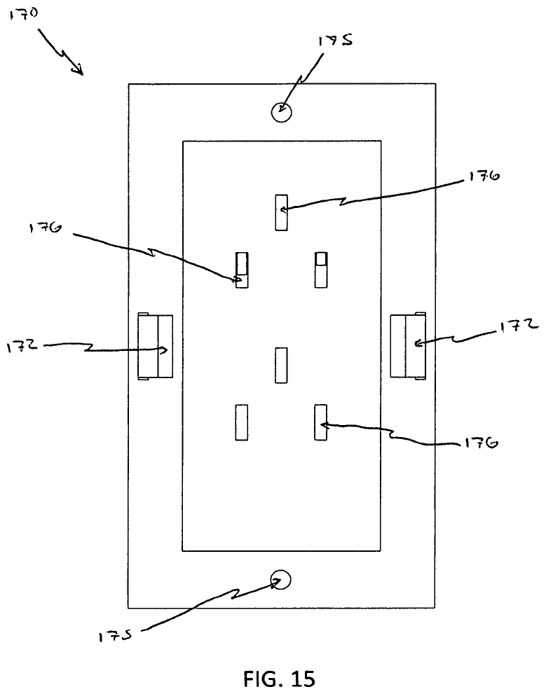

An embodiment of an optional clip-on module 170 is shown in FIGS. 11-15. The clip-on module 170 is shown with two plugs 171 for attachment of standard U.S. electrical connections, though it should be understood that other types of plugs 171 or functional elements may also be used without deviating from the scope or intent of this disclosure, including European plugs, USB ports, and other electrical or signal connection features. Additionally or alternatively, electrical switches, light sockets, lights, carbon monoxide detectors, smoke detectors, and other elements may also be placed with the plugs or instead of them, making use of the connectivity of the clip-on module 170 to a starter-module 110 or an add-on module 140 to be described. Further, though a clip-on module 170 is shown which would entirely take up the front connectivity of the embodiments of starter modules 110 or add-on modules 140 as depicted in the figures of this disclosure, it should be understood that more than one clip-on module 170 may be used or multiple different types of clip-on modules 170 may be used interchangeably or simultaneously with the starter modules 110 or add-on modules 140 disclosed herein, and the starter modules 110 and add-on modules 140 disclosed herein might include multiple attachment features 121, 151 to enable connectivity with multiple clip-on modules 170. The clip-on module 170 is also shown without prongs extending from the rear of the clip-on module 170, though it should be understood that an assembled clip-on module 170 may include prongs, such as portions of internal buss bars 130 which may extend out from the clip-on module 170 to create connectivity with a starter module 110 or add-on module 140.

The clip-on module 170 may be connected to a starter module 110 or an add-on module 140 in such a way as to be at least partially recessed within it, to be flush with it, or to be at least partially proud from it. The clip-on module 170 may include one or more attachment features 172 to aid in retention of the clip-on module 170 with a starter module 110 or an add-on module 140, such as in a configuration where the one or more attachment features 172 connect to or function in conjunction with one or more attachment features 121, 151 on the starter module 110 or add-on module 140. In the embodiment shown, the clip-on module includes two prongs 172 which may be inserted into clip attachment features 121, 151 in the starter module 110 or add-on module 140. These prongs 172 may be sized, shaped, scored, or made of a material so as to plastically deform when inserted into the clip attachment features 121, 151 and then return to an orientation where they will resist removal of the clip-on module 170, though it should be understood that flexion could also or alternatively take place in the clip attachment features 121, 151. It should also be understood that other means of retention of the clip-on module 170 to the starter module 110 or the add-on module 140 may also be used without deviating from the scope or intent of this disclosure, including, but not limited to, snap fits, press fits, cam features, and threading features such as screws or bolts.

The clip-on module 170 may include a primary face 173, such as to sit flush with the starter module 110 or add-on module 140, though it may also optionally include one or more secondary faces 174. In the embodiment shown, the secondary face 174 is proud from the primary face 173, such as to enable attachment of an optional cosmetic face plate by optional means, such as screw holes 175. It should be understood, however, that there may also be no secondary face 174, a plurality of secondary faces 174, one or more secondary faces 174 of different shapes and/or sizes, the one or more secondary faces 174 may be recessed relative to the primary face 173, or a combination of the above, depending on the desired use of the clip-on module 170.

Similarly to the starter module 110 and the add-on module 140, the clip-on module 170 may include means of electrical or other signal conduction, such as wires or buss bars 130. The clip-on module 170 may include channels (not shown) for seating or retention of the wires or buss bars 130, which may be located in the main body 177 of the clip-on module 170. The clip-on module 170 may also include prongs or wires for connection of the clip-on module 170 to one or more ports 123, 153 in a starter module 110 or add-on module 140, though these prongs are not shown in the interest of clarity. The clip-on module 170 may also include ports 176 allowing extension of prongs or wires from the clip-on module 170 or, alternatively, allowing for prongs from a starter module 110 or add-on module 140 to extend into the clip-on module 170.

The clip-on module 170 may include one or more release openings 178, which may aid in release of the clip-on module 170 from a starter module 110 or add-on module 140. In the embodiment shown, the release openings 178 enable insertion of a tool, such as a flat-head screwdriver, to press the one or more prongs 172 to be released from their locking position with their associated attachment features 121, 151 in a start module 110 or add-on module 140.

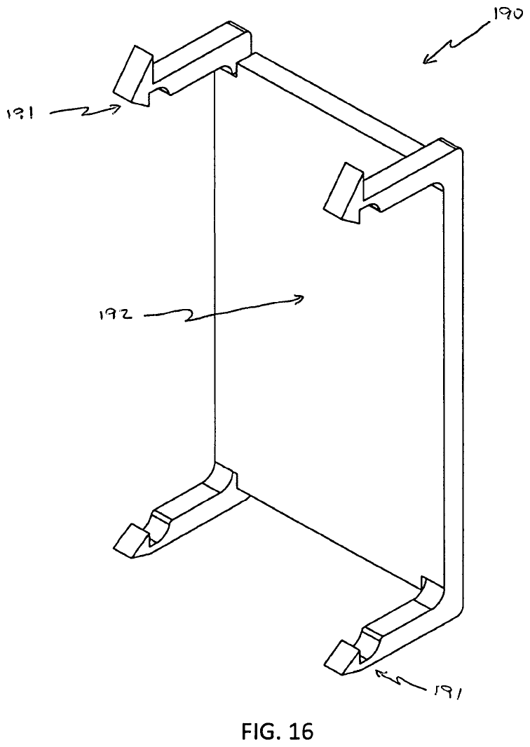

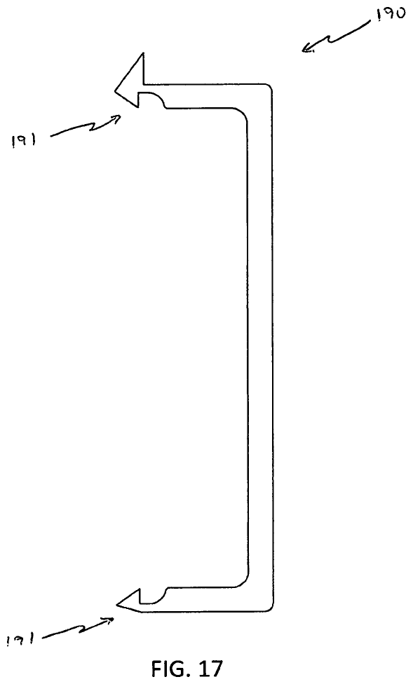

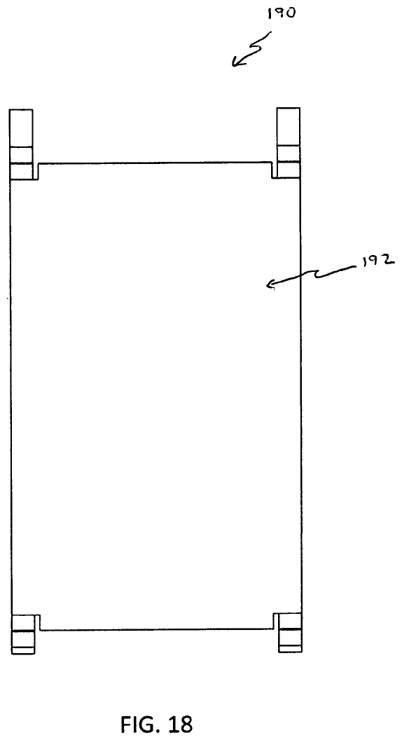

An embodiment of an optional wire manager component 190 is shown in FIGS. 16-18. the wire manager 190 may be configured to connect to or removably attach to a starter module 110 or an add-on module 140, so as to protect wires or other connections being made to the starter module 110 or add-on module 140. In such a way, someone installing a start module 110 or add-on module 140 may make electrical connections with it and leave it in place during further work without concern of damage to wiring or the connections being made with the wiring.

The wire manager 190 may include one or more connection features 191 which may be configured for retention with associated features 126, 156 on a starter module 110 or add-on module 140. The wire manager 190 may also include a backing wall 192 to protect wires or other elements connected to a starter module 110 or add-on module 140. In the embodiment shown, the backing wall 192 is shown as planar and substantially solid, while also being rectangular, though it should be understood that other shapes and form factors may also be used, such as ones where the backing wall 192 includes ridges, prongs, or other features to further aid in segregation of wiring, cutaways to aid in bending or wiring around the backing wall 192 where it may be desirable, or sidewalls or top or bottom walls to further aid in protection of wiring or other elements.

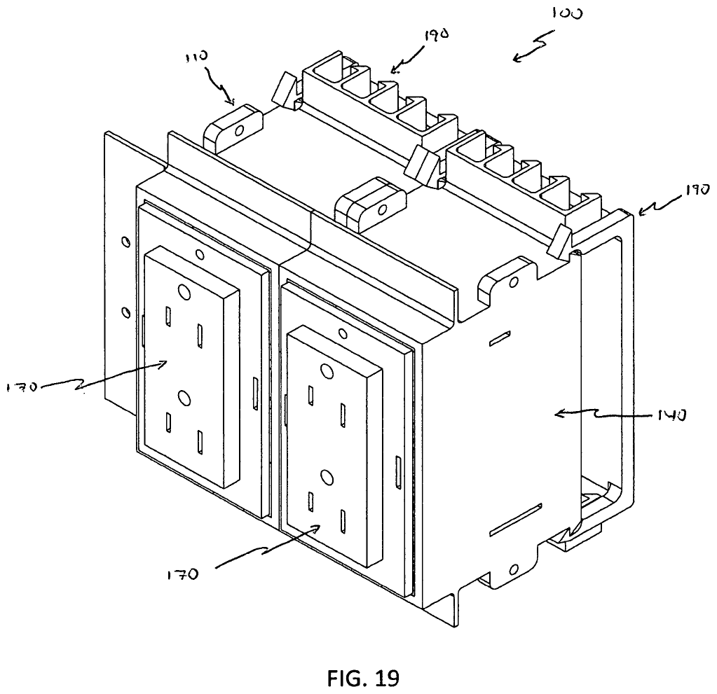

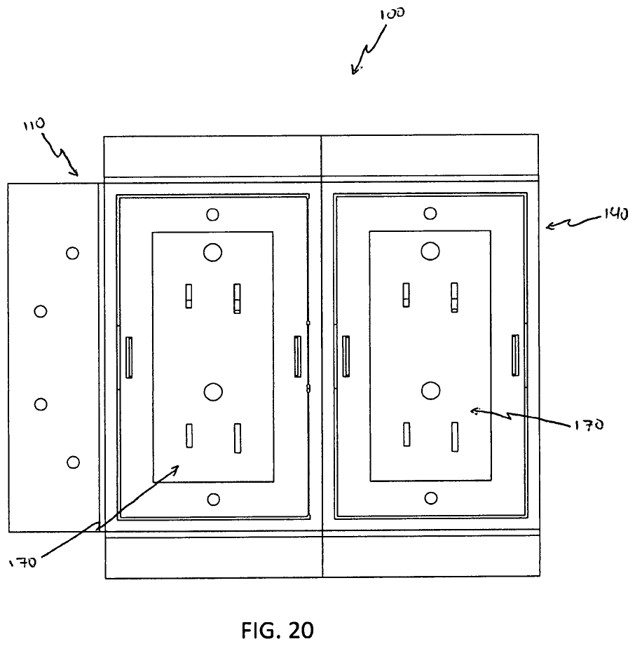

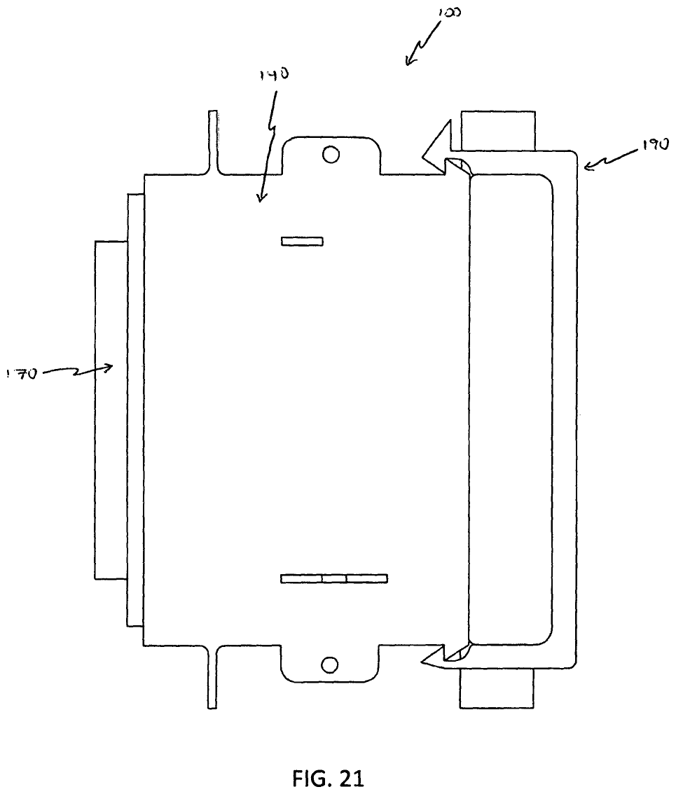

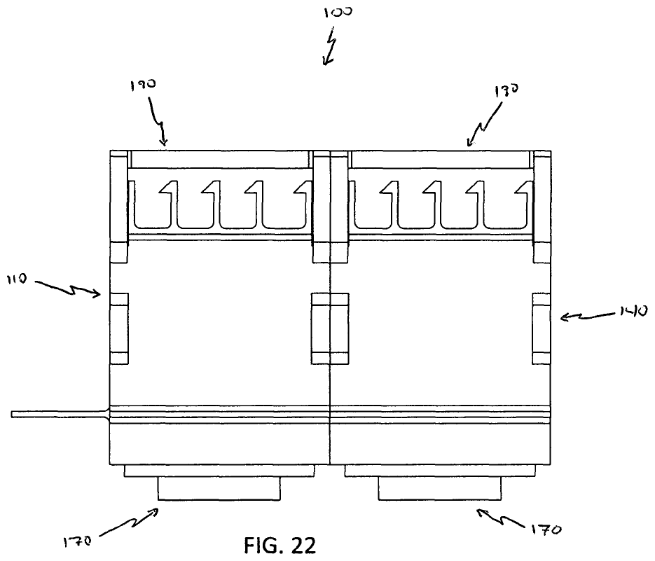

An embodiment of a multi-piece modular connector unit 100 is shown in FIGS. 19-22. The modular unit 100, as shown, includes a starter unit 110, a clip-on module 170 and a wire manager 190 connected to the starter unit 110, and an add-on module 140 connected to the starter module 110, with both a second clip-on module 170 and a second wire manager 190 connected to the add-on module 140. Though not shown, it should be understood that the add-on module 140 may be connected to the starter module 110 merely by connector prongs extending between one or more ports 125 on the starter module 110 and one or more ports 155 on the add-on module 140, or by connecting components or features between one or more of the starter module 110 attachment features 120 and one or more of the add-on module 140 attachment features 150. The add-on module 140 may optionally be connected to the starter module 110 by means of screws, bolts, clips, snap-fit features or components, zip ties, or other means known in the art. Additional add-on modules 140 may also be connected by similar means.

Though two identical clip-on modules 170 are shown, one connected to the starter module 110 and the other connected to the add-on module 140, it should be understood that two or more different types or configurations of clip-on modules 170 may be used, or only one clip-on module 170 may be used, without deviating from the scope or intend of this disclosure. Similarly, though two identical wire managers 190 are shown, one connected to the starter module 110 and the other connected to the add-on module 140, multiple configurations or shapes of wire managers 190 may also be used. Alternatively, only one wire manager may be used, such as where external wiring is only connected to one component, such as only to the starter module 110. In such an embodiment, there may be no wire manager 190 on one or more add-on modules 140, or an alternative embodiment of a wire manager 190 may be used, such as one which covers the rear wire openings (not shown, but functionally equivalent to the rear wire openings 124 of the starter module 110) of the add-on module 140. In embodiments where the add-on module does not include rear wire openings, no wire manager 190 may be necessary.

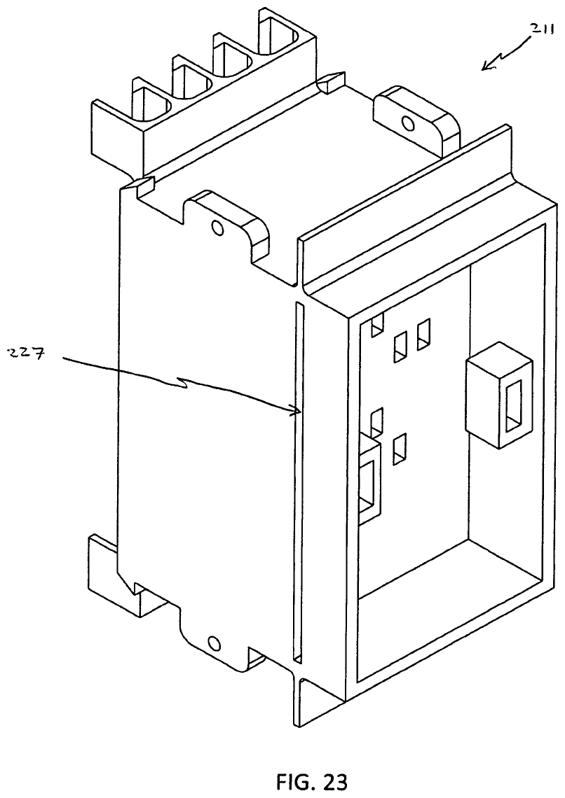

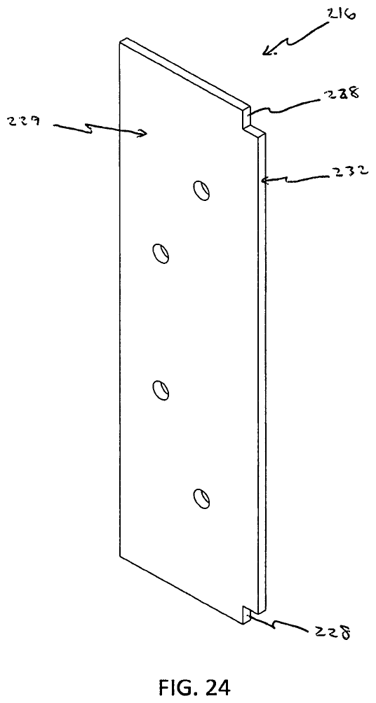

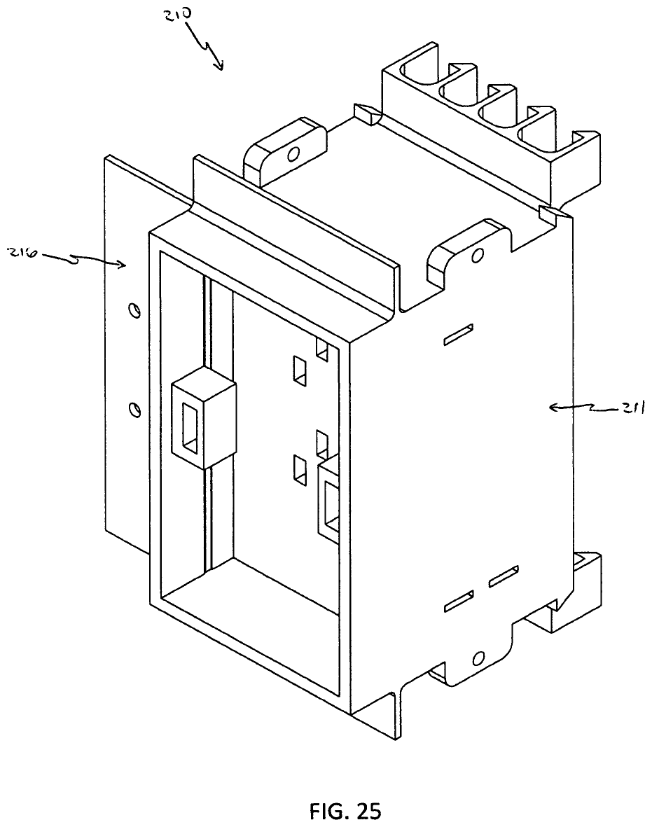

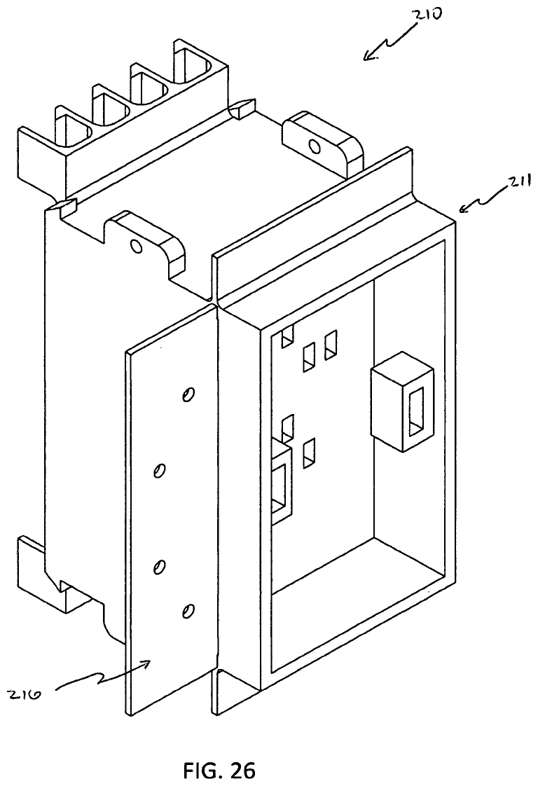

Alternate embodiments of a starter module 211, optional attachable flange 216, and assembled starter module 210 (shown in front right isometric view and front left isometric view) are shown in FIGS. 23-26, respectively. In some embodiments, it may be desirable to have a flange 216 optionally removable, such as where surrounding structures such as studs or walls prevent the use of a standardized flange 216 or where different sizes, shapes, or configurations of flanges 216 may be desirable. From a manufacturing perspective, it may be desirable to have the starter module 211 and the add-on module 140 be identical, with different buss bars 130 being inserted into identical channels 131 and with a flange 216 being optionally connected to the module with buss bars 131 configured for that module to be used as a starter module 210.

In the embodiment shown, the starter module 211 includes at least one opening 227 configured to receive at least a portion of the flange 216. The flange 216 itself may optionally include one or more depth stop features 228 to prevent the flange 216 from being seated too far within the starter module 211, such as where it may prevent proper attachment of a clip-on module 170 to the starter module 211. The depth stop feature 228 may also or alternatively be in the form of a thickening of the flange 216 or additional features or elements on the flange 216, such as ribs, pins, other proud features, or a ratchet-like feature. The flange 216 may be welded to the starter module 211, or may be attached through other means, such as a press-fit, a snap fit, a clipping feature of element, a set screw, or other means known in the art. It may be desirable to have the flange 216 be attachable or, optionally, removably attachable, to the starter module 211, such as where a user may select an appropriate configuration of flange 216 for a given intended use. In some alternate embodiments, it may be desirable for the primary flange surface 229 to be offset from the flange insertion feature 232, such as where a single flange opening 227 may be used to accommodate flanges 216 with different offsets, allowing for different placement of the starter module 211 relative to any studs or other features or surfaces to which the assembled starter module 210 is being attached.

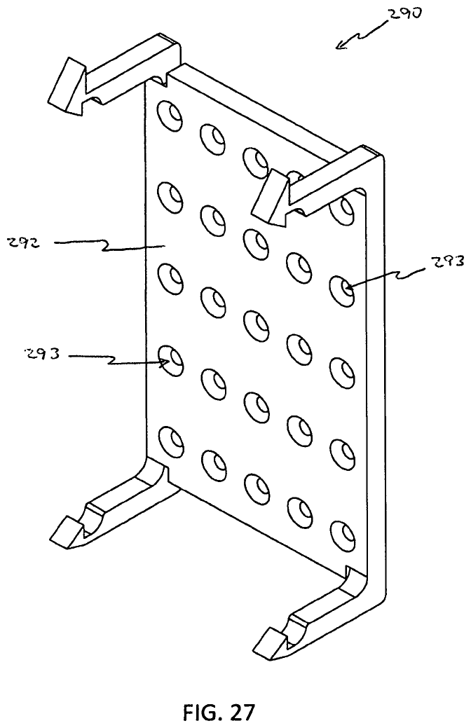

An alternate embodiment of a wire manager 290 is shown in FIG. 27. The wire manager 290 may include one or more wall openings 293, which may be recesses in the backing wall 292 or may, as shown, be holes 293 which pass through the backing wall 292. One or more openings 293 may reduce weight of the wire manager 290 while also being configured to substantially maintain the rigidity of the wire manager 290 and also maintain protection of any wires which may be attached to one or more components of a device assembly 100. Though not shown, one or more wall openings 293 may be at last partially open to a top, bottom, or side of the wire manager 290, allowing for additional routing or desired locating of associated wires which may at least partially pass through a wall opening 293.

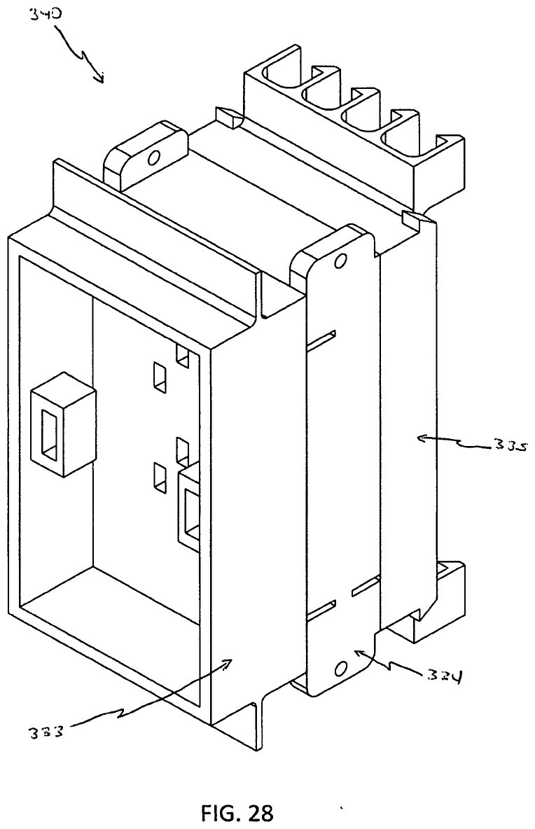

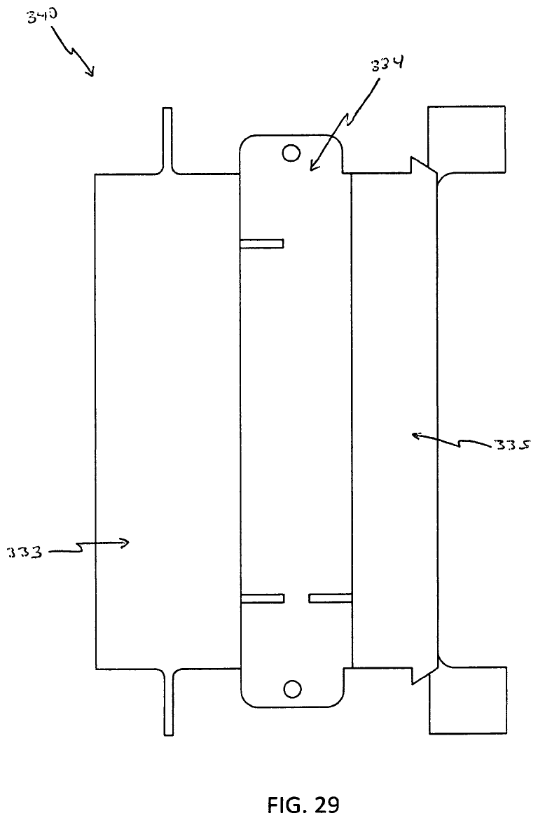

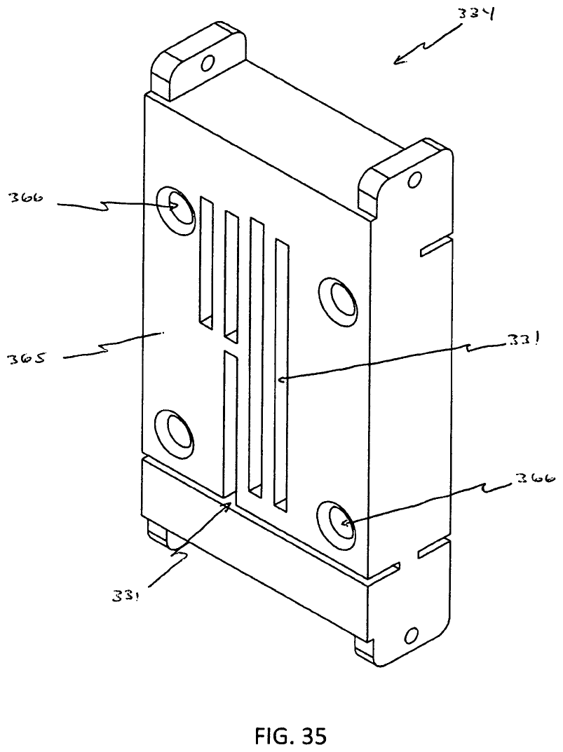

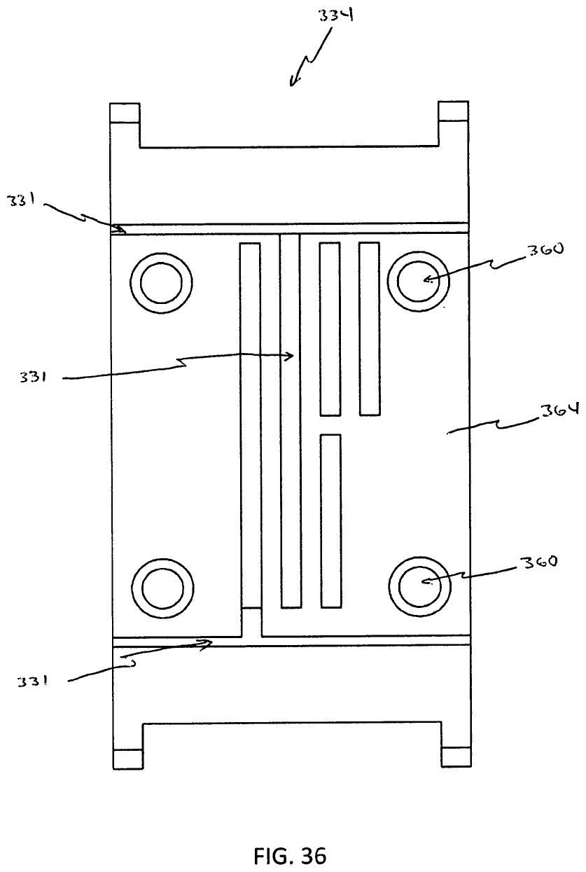

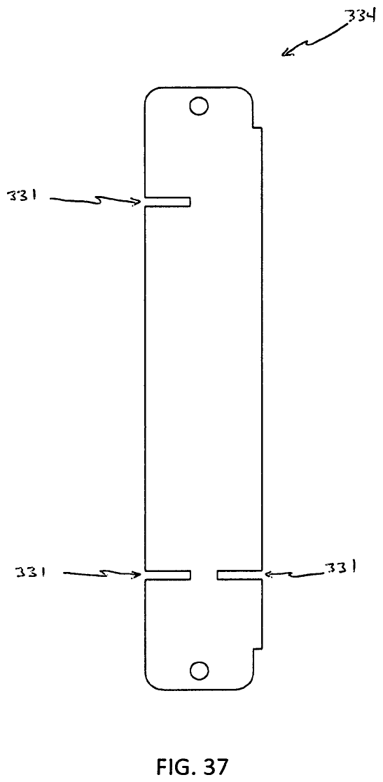

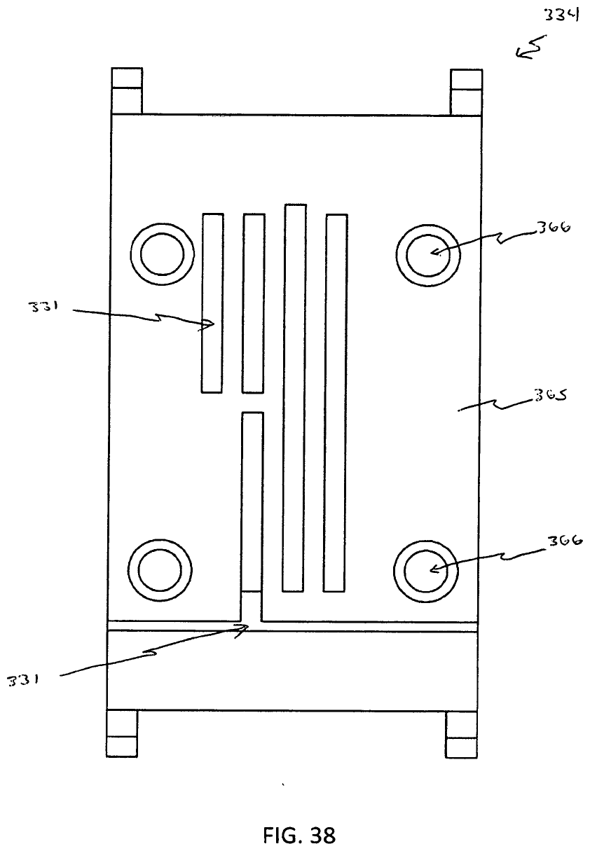

In other embodiments, the starter module 110, the add-on module 140, or the clip-on module 170, or some or all of the above, may be made of multiple sub-components. FIGS. 28-38 depict an alternate embodiment of the add-on module 340 which is made up of multiple sub-components, though it should be understood that the starter module 110 may similarly be made up of multiple sub-components.

In the embodiment shown, the add-on module 340 is made up of a front component 333, a middle component 334, and a back component 335. It should be understood that fewer sub-components or more sub-components may also be used without deviating from the scope or intent of this disclosure, such as in embodiments where features which may not be desirable for all applications may be additional subcomponents which may be optionally removed or omitted or where different breakdowns of the add-on module 340 may be beneficial for manufacturing purposes.

The front component 333 may connect to the middle component 334. The middle component 334 may connect to the back component 335. The components may be connected by means of a press fit, a snap fit, welding, screws, bolts, connection by deformable tabs or other features, or by other means known in the art. In other embodiments, the front component 333 may connect to the back component 335, thereby at least partially capturing the middle component 334 between the front component 333 and the back component 335. This may be done by passing the one or more connecting features between the front component 333 and the back component 335 directly through one or more openings in the middle component 334 or where the one or more connecting features extend around at least a portion of the middle component 334.

For the purposes of aiding in manufacturability or aiding in assembly, or for allowing a user to select whether the add-on module 340 is used as an add-on module 340 or as a starter module 110, it may be desirable to group features for retention of buss bars 120, such as channels 331, in one single component, or in different components which may better retain the buss bars 130 during assembly.

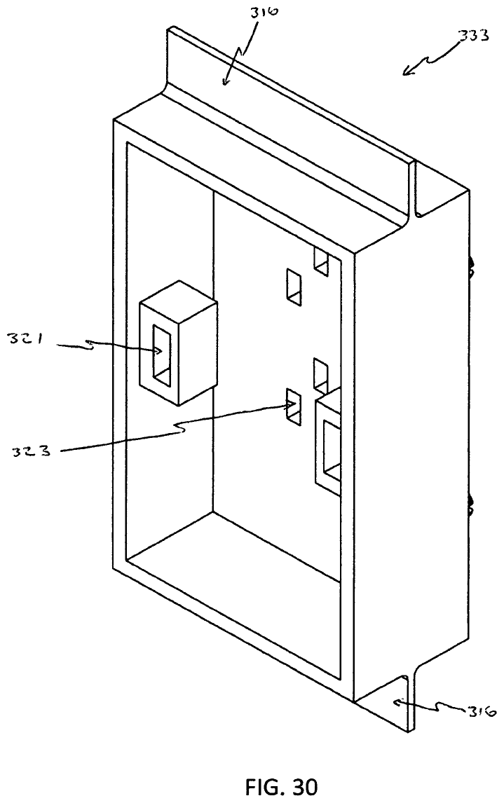

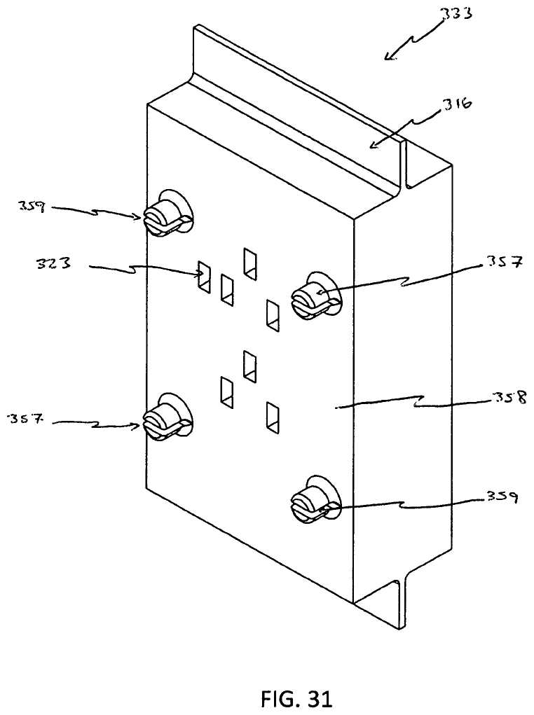

As shown in FIGS. 30-31, the front component 333 may include one or more ports 323 to enable connectivity between one or more clip-on modules 170 and one or more buss bars 130 or other internal conducting elements. The front component 333 may also include one or more clip-on attachment features 321 for attachment or retention of one or more clip-on modules to the add-on module 340. Though two flanges 316 are shown on the front component 333, it should be understood that one or more of these flanges 316 may be absent, may be located on other components, such as the middle component 334 or the back component 335, or more flanges 316 may also be present. The front component 333 may include one or more connection features 357 to enable connection or retention of the front component 333 to the middle component 334. In the embodiment shown, the front component 333 includes four connection features 357 which extend away from the rear face 358 of the front component 333, though fewer or more connection features 357 may also be used. The connection features 357 are shown as substantially cylindrical, though it should also be understood that other shapes, such as rectangles, triangles, hexagons, octagons, or compound shapes, may also be used. The connection features 357 are configured to be received by substantially matching connection openings 360 in the middle component 334. The connection features 357 may either be sized to form a slip fit with the associated matching connection openings 360, a press fit, or other fit as may be desired, including for retaining the front component 333 with the middle component 334 indefinitely or for alignment during welding or other affixing of the front component 333 to the middle component 334.

Similar connections will be described for the middle component 334 and the back component 335, though it should be understood that similar embodiments and connection features and tolerances may also be used. In the embodiment shown, each of the connection features 357 includes at least one slot 359 to control flexion and deformation of the connection features 357 during insertion into their matching connection openings 360, though it should be understood that more slots 360, no slots 360, or slots 360 on only some of the connection features 357 may also be used. The connection features 357 may also be rigid, such as for a press fit with the connection openings 360 or where deformation of flexion is preferred in the connection openings 360. It should also be understood that, in alternate embodiments, the front component 333 or the back component 335, or both, may include connection openings 360 while the middle component 334 may include one or more connection features 357.

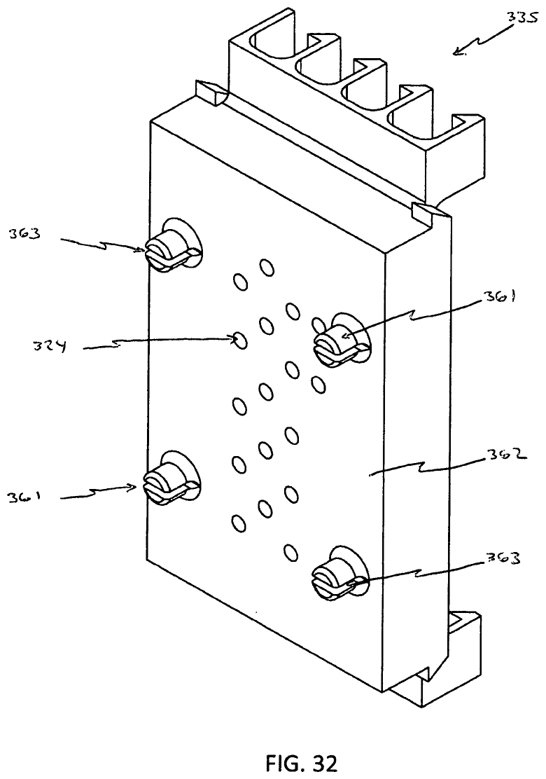

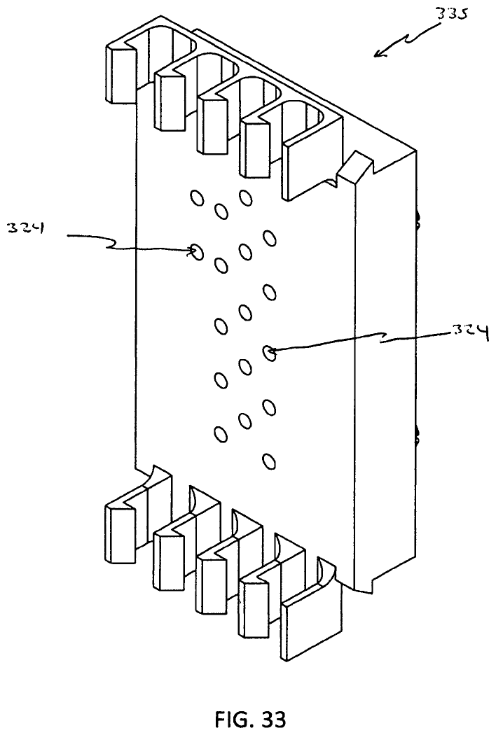

In one embodiment, as shown in FIGS. 32-33, the back component 335 may include one or more connection features 361 which may extend away from the front face 362 of the back component 335. One or more of the connection features 361 may include one or more slots 363 to aid in or control flexion during connection of the rear component 335 to the middle component 334. As described in relation to the front component 333, the connection features 361 may take a range of different shapes and configurations without deviating from the scope or intent of this disclosure, including press fits and snap fits. The back component 335 may include one or more wire openings 324 which may extend partially or entirely through the back component 335. Though not shown, the back component 335 may also include wire retention elements, as known in the art, such as springs or stab connectors, for retaining one or more wires within the add-on module 340. These wire retention elements may also or alternatively be located in the middle component 334, or may be absent. In one embodiment, wires pass through the wire openings 324 in the back component 335 and are retained by stab connectors in the back component 335, creating an electrical connection with buss bars 130 in the middle component 334 when the middle component 334 and back component 335 are themselves connected. The optional stab connectors may be sized to wiring that is anticipated to be inserted, such that barbs on the inside walls of the relative components, which may be plastic or made of another flexible material, allow the wires to be held in position without the need of clamps or other similar mechanisms.

Though no buss bar channels 331 are shown in either the front component 333 or the back component 335, it should be understood that channels 331 may be located in either or both of the front component 333 and the back component 335.

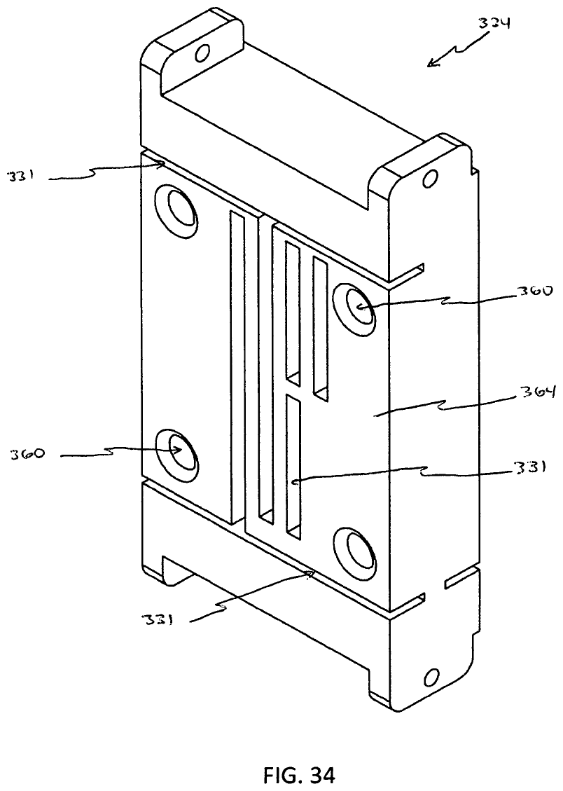

An embodiment of a middle component 334 is shown in FIGS. 34-38. The middle component may include a front face 364 which may further include one or more connection openings 360. The front component 334 may include a back face 365 which may further include one or more connection openings 366. It should be understood, however, as discussed above, that the middle component may have other types of connection features 360, 366 and may include one or more proud connection features 357, 361. In the embodiment shown, the front connection openings 360 and the rear connection openings 366 are effectively, in regards to each pairing, a single opening, as the front connection openings 360 pass through to the back connection openings 366. However, it should be understood that, in other embodiments, the front connection openings 360 and back connection openings 366 may be entirely or partially separate and may be at least partially disconnected.

In the embodiment shown, the middle component 334 includes multiple channels 331 for insertion and/or retention of one or more buss bars 130, though it should be understood that there may be more or fewer channels 331, and that the channels 331 may alternatively or additionally be located within the front component 333, the back component 335, or both. The channels 331 may be sized to receive at least part of a buss bar 130, may be sized to closed match the size and shape of one or more buss bars 130, or may be sized and shaped to allow one or more gaps for retention of a connecting element, such as a prong, in contact with one or more buss bars 130 or to enable insertion of coating with an insulating material surrounding one or more of the buss bars 130, including in embodiments where the middle component 334 is not made of an electrically insulating material. In other embodiments, the middle component 334 may be made of an electrically or thermally insulating material, while the front component 333, the back component 335, or both, may optionally be made of an electrically or thermally conductive material. The front component 333, the middle component 334, and the back component 335 may all be made of the same material, or may be made at least partially out of different materials, including hybrids consisting of multiple materials.

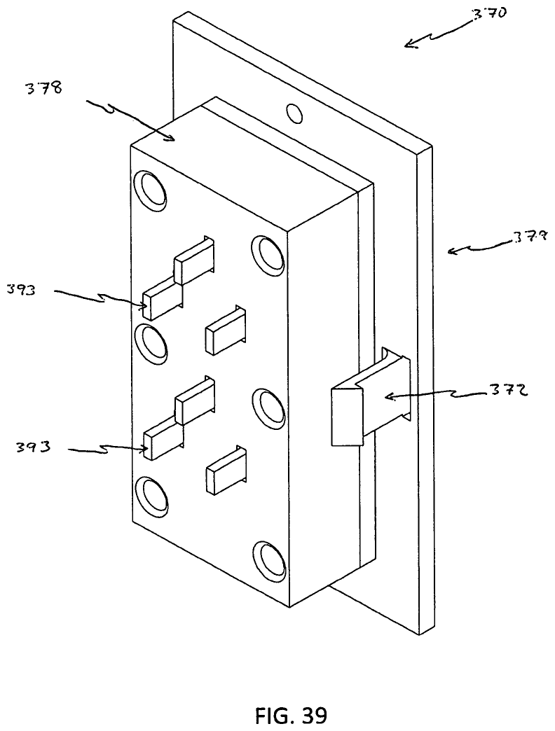

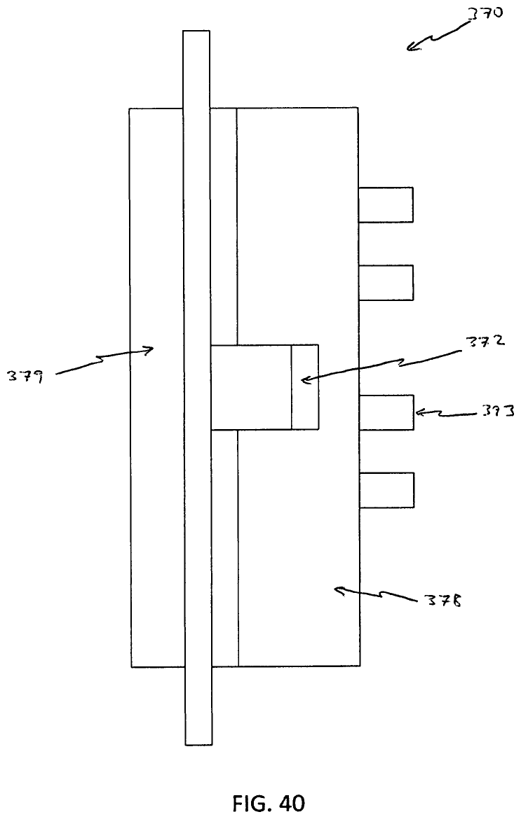

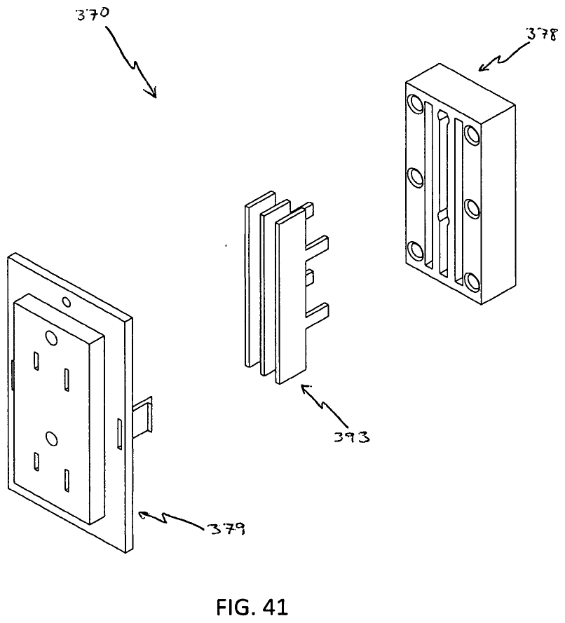

An embodiment of a multi-piece clip-on module 370 is shown in FIGS. 39-41. The clip-on module 370 may include a front component 379, a back component 378, and one or more buss bars 393. In the embodiment shown, the buss bars 393 optionally extend from the back component 378, effectively creating prongs to connect to electrically conductive elements in the add-on module 340 or in the starter module 110, though it should be understood that prongs may be a separate component or may extend from a different component into the clip-on module 370.

The front component 379 of the clip-on module 370 may include one or more connection features 372, thereby having the connection of the clip-on module 370 to a starter module 110 or an add-on module 340 aiding in retention of the front component 379 to the back component 378, though it should be understood that one or more of the retention features 372 may additionally or alternatively be located on the back component 378. The front component 379 and the back component 378 may be connected through a variety of means, similarly to those described regarding connection of sub-components of the add-on module 340 above, including press fits, snap fits, and welding.

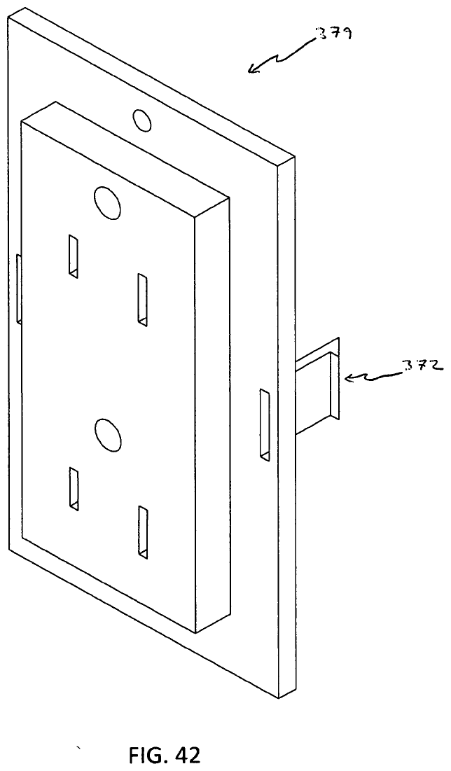

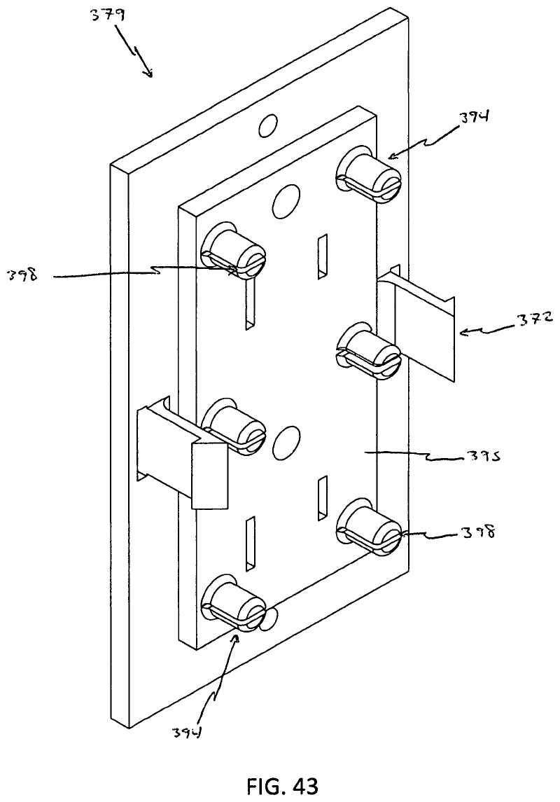

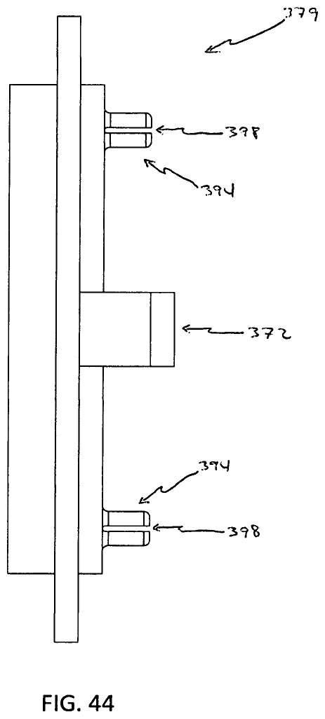

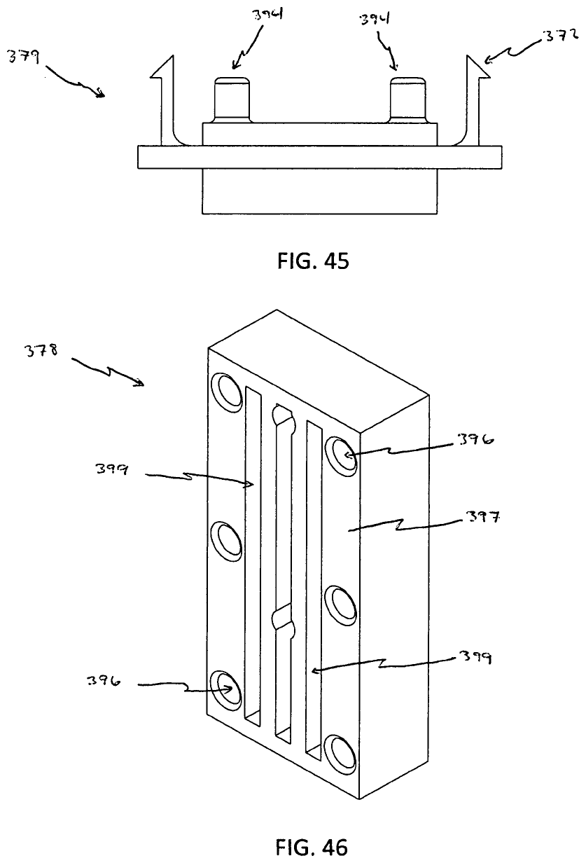

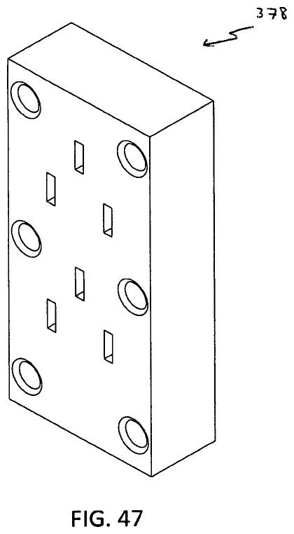

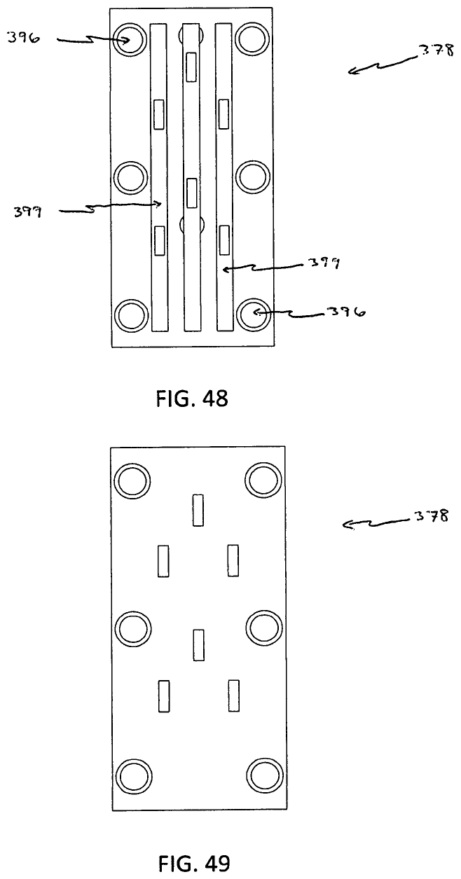

FIGS. 42-45 show an embodiment of the front component 379 of the clip-on module 370. FIGS. 46-49 show an embodiment of the back component 378 of the clip-on module 370. Similarly to the components 333, 334, 335 of the add-on module 340, the front component 379 and the back component 378 may feature different types of connection means. In the embodiments shown, the front component 378 includes one or more connection features 394 which may extend from a back face 395 of the front component. The connection features 394 may further include one or more slots 398 on some, all, or none of the connection features 394. The back component 378 may include one or more complementary connection openings 396 at a front face 397 of the back component 378 or, optionally, extending through the back component 378. As discussed above in relation to the add-on module 340, various means of connection between the font component 379 and the back component 378 of the clip-on module 370 may be used without deviating from the intent or scope of this disclosure.

The back component 378 of the clip-on module 370 may include one or more channels 399 receiving or retaining one or more buss bars 393 or other means of electrical or signal transmission or connectivity. The materials and spacing of the channels 399 and the front component 379 and back component 378 may be varied and selected, similarly to the components 333, 334, 335 of the add-on module 340. The buss bar channels 399 are depicted within the back component 378, but it should be understood that they may optionally be additionally or alternatively located within the front component 379.

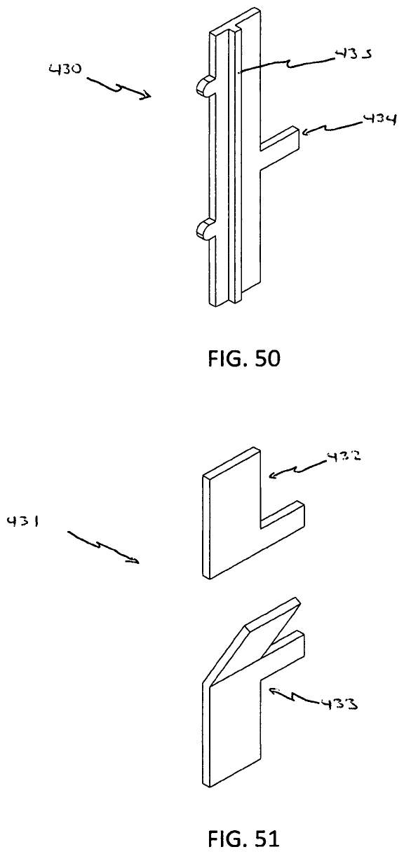

FIGS. 50-51 show two different embodiments of buss bars 430, 431, though it should be understood by one skilled in the art that a range of other configurations, shapes, and interactions between buss bar components 430, 431 may also be used without deviating from the intent or scope of this disclosure. FIG. 50 shows a buss bar 430 such as may, by way of example, be used as a ground buss bar 430 for a clip-on module 370. The ground buss bar 430 may optionally include one or more prong features 434 which may extend from the clip-on module 370 to create electrical connectivity with a starter module 110 or an add-on module 340.

The ground buss bar 430 may also include a rib 435, bend, or other feature to function as a stopper for a prong of a device plugged into the clip-on module 370, to create a better connection with it, or to better fit within a channel 399. It should be understood that similar features 434, 435 may be present on other buss bars 130, 393. The rib 435 may also be located on a buss bar 430 so as to allow wiring which is inserted and held in place, such as by stab-in connectors, to make a connection to a given module both along the length and at the end, leading to a more consistent and reliable connection without necessitating the use of springs.

FIG. 51 shows a switch buss bar component 431, which may be part of an alternate embodiment of a clip-on module 370. The switch buss bar component 431 may include a first buss bar element 432 and a second buss bar element 433, which the second buss bar element 433 may include a flexible or rotatable area which may be positioned so as to create an electrical circuit between the first buss bar element 432 and the second buss bar element 433, or may be rotatable so as to break the circuit.

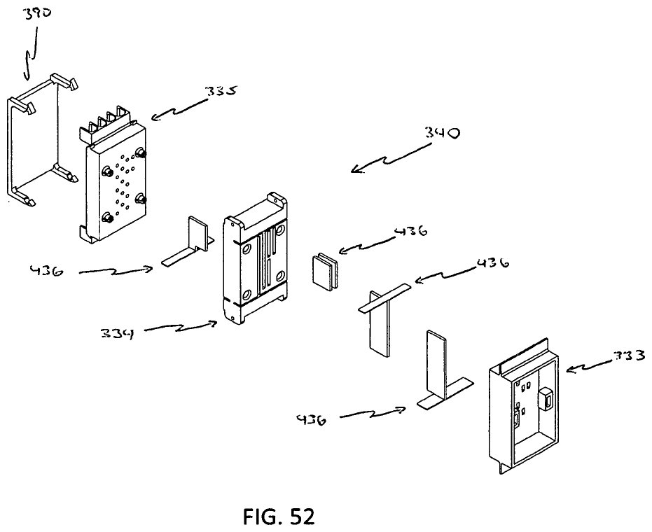

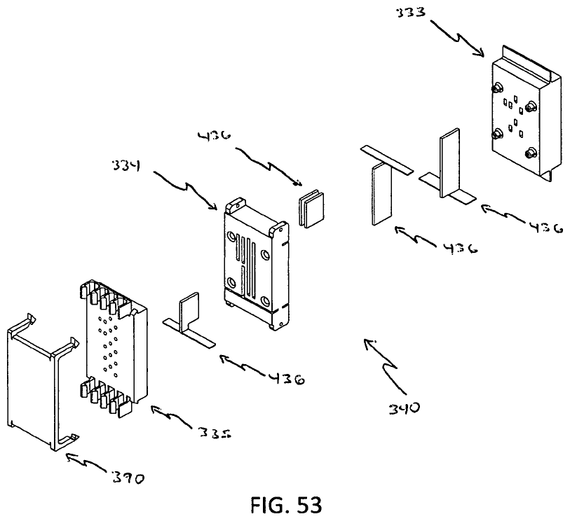

Exploded views of an add-on module 340, including a wire manager 390 and assorted internal buss bar components 436 are shown in FIGS. 52-53. In one method of assembly, one or more buss bar components 436 may be inserted into channels 331 in the middle add-on module component 334. The back add-on module component 335 and the front add-on module component 333 may be connected to the middle add-on module component 334. The wire manager 390 may be connected to the add-on module 340. It should be understood that this method may be alter which component 333, 334, 335 has buss bar components 436 inserter into it depending on which component 333, 334, 335 has buss bar channels 331 in a given embodiment.

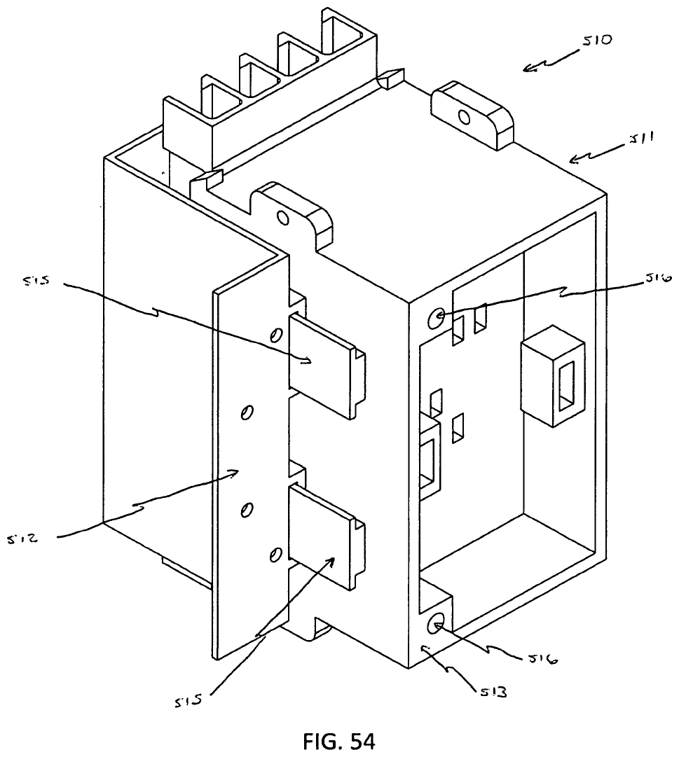

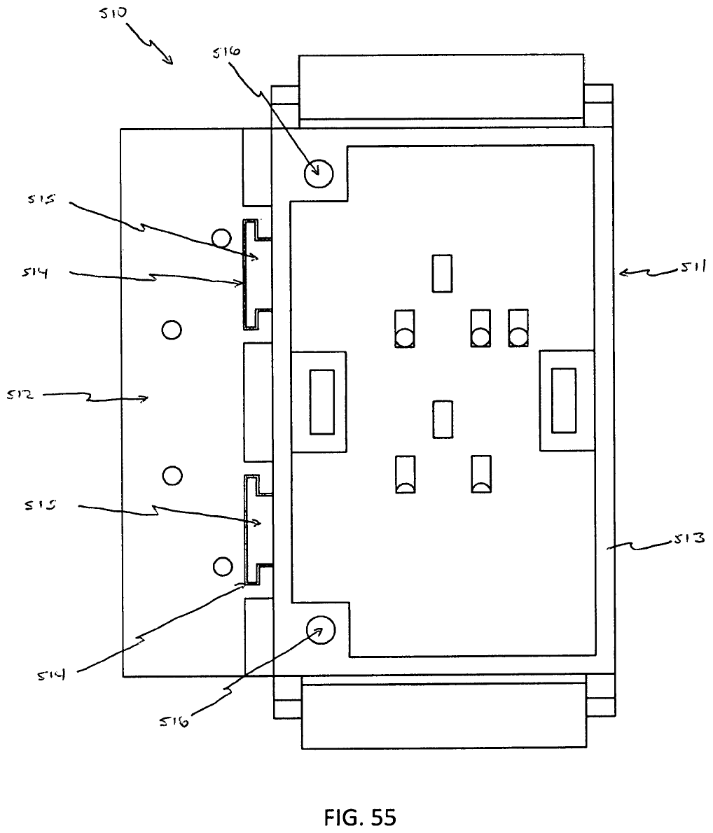

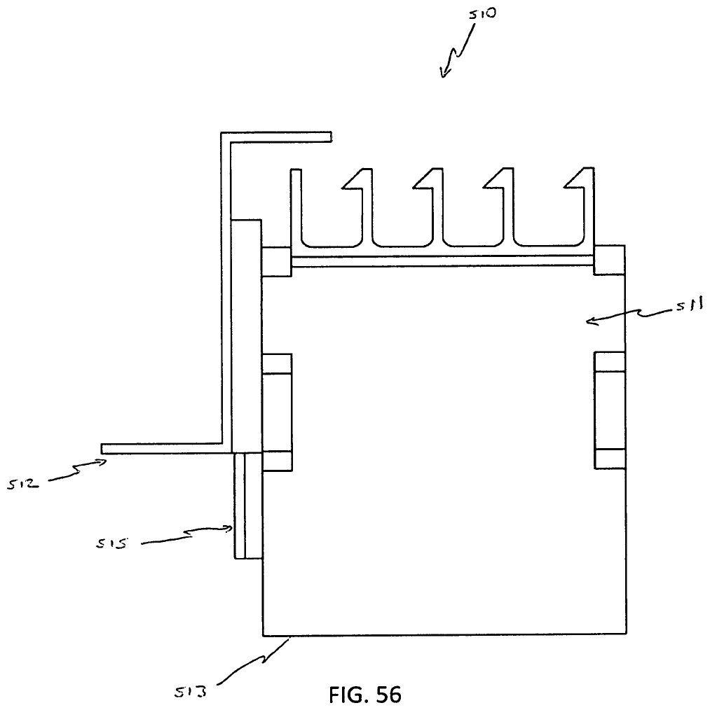

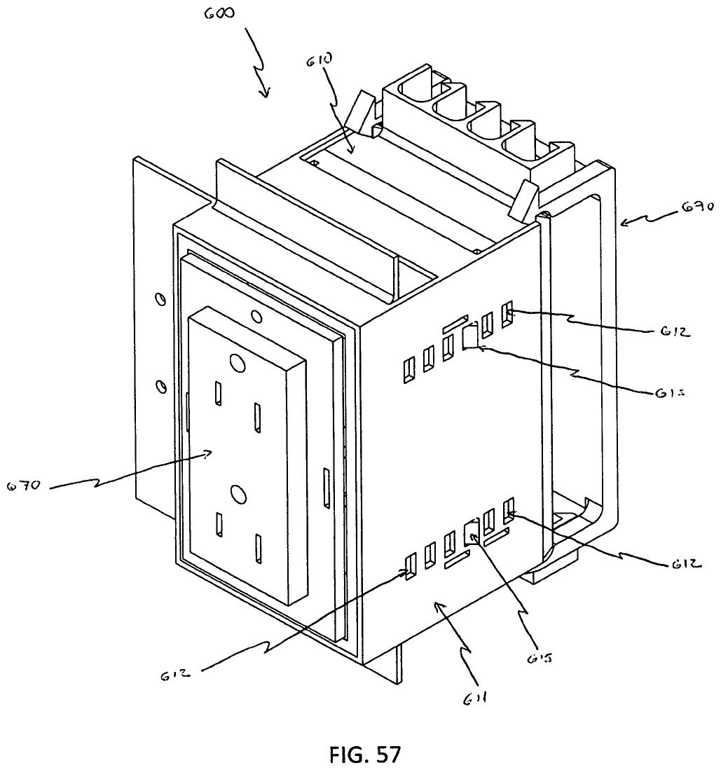

An alternate embodiment of a starter module 510 is shown in FIGS. 54-56. The starter module 510 may include a primary starter module body 511 and an adjustable flange component 512. The adjustable flange component 512 may be configured to be connectable to the primary starter module body 511 at various offsets relative to the front face 513 of the primary starter module body 511. The adjustable flange component 512 may include one or more slots 514, such as a dove tail or t-slot, configured to receive a complementary slider feature 515 on the primary starter module body 511. It should be understood that the location of the one or more slots 514 and the one or more slider features 515 may be switched or mixed between the adjustable flange component 512 and the primary starter module body 511 without deviating from the scope of intent of this disclosure. The adjustable flange component 512 may freely slide on the slider feature 515, may be a press fit, or may include a ratcheting feature so as to aid in retaining the location of the adjustable flange component 512 relative to the primary starter module body 511. The primary starter module body 511 may also optionally include one or more location holes 516, which may optionally be fully or partially threaded, for setting and/or retaining a depth of the starter module 510 relative to any surrounding structures. By way of example, a threaded component such as a screw or bolt was be inserted into a hole 516 and threaded to a desired depth, with a desired amount of the screw exposed from the back of the primary starter module body 511, so as to locate the primary starter module body 511 relative to surrounding structures and relative to the adjustable flange component 512.

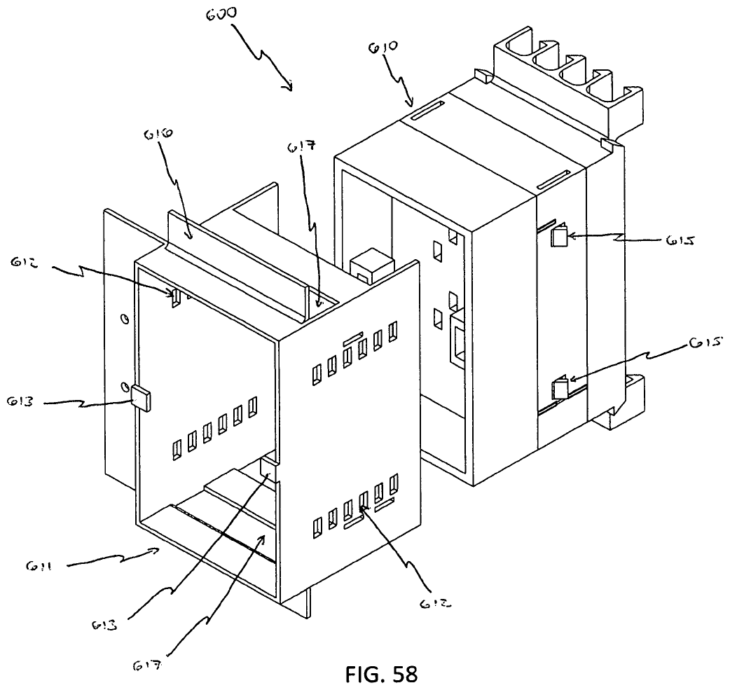

An alternate embodiment of a starter module 610, a clip-on module 670, a wire manager 690, and an adjustable mounting bracket 611, are shown in FIG. 57. The mounting bracket 611 may be mounted to surrounding studs or other attachment surfaces or features prior to insertion of the starter module 610 into the mounting bracket 611 or the starter module 610, with or without the wire manager 690, may be inserted into the bracket 611, which may then be attached to studs or other surfaces. The starter module 610 may include one or more zip tabs 615 which may flex when the starter module 610 is inserted into the mounting bracket 611, allowing a user to insert the starter module 610 to a desired depth relative to surrounding mounting structures, such as studs or drywall. The mounting bracket 611 may include one or more zip tab holes 612 which may resist undesired backing out of the starter module 610 from the mounting bracket 611. It should be understood that the zip tabs 615 may alternately be located on the mounting bracket 611, with the zip tab holes 612 being instead located on the starter module 610, without deviating from the scope or intent of this disclosure. The starter module 610 and adjustable mounting bracket 612 are shown in an unassembled configuration in FIG. 58. The mounting bracket 611 may include one or more tabs 613 to resist the starter module 610 being pushed too far forward within the adjustable bracket 611. The tabs 613 may be removed after assembly, or may be movable, such as by flexing outwards, bending inwards to grip the starter module 610, or by sliding relative to the remainder of the adjustable bracket 611. It should be understood that other modules may also be inserted into the adjustable bracket 611 in a similar fashion.

The adjustable bracket 611 may also include one or more openings 617, which may be created by bending one or more flanges 616. The openings 617 may be cut or molded during manufacturing, with the flanges 616 being bent out, or a user may option bend out flanges 616 as desired during installation.

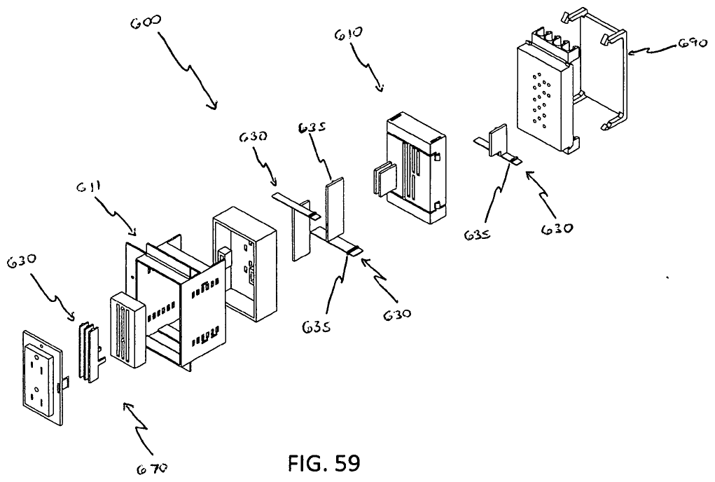

FIG. 59 shows an embodiment of the modular electrical connector unit 600 with a starter module 610, wire manager 690, clip-on module 670, and adjustable mounting bracket 611 in an unassembled and exploded configuration and view. As shown, the various buss bar components 630 include ribs 635 to act as positive stops when prongs or wires are inserted and contact the buss bars 630. The ribs 635 prevent wires or prongs from pushing too far in while also providing improved contact with the buss bar 630.

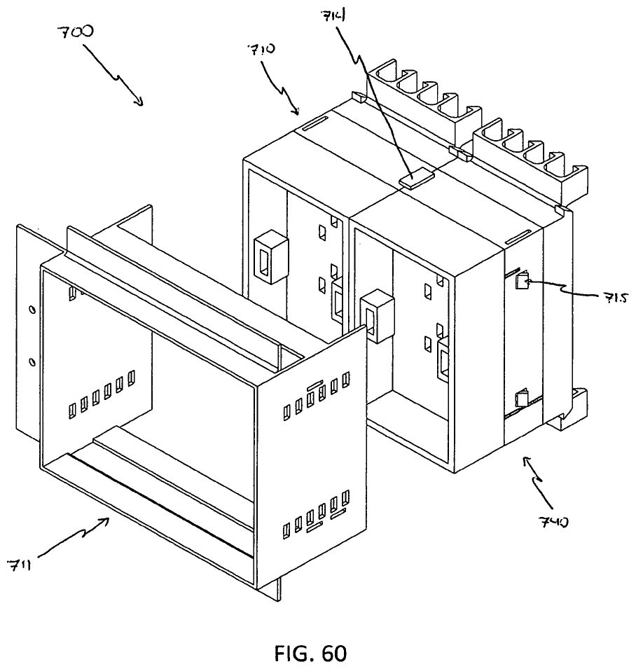

An alternate embodiment of a modular connector unit 700 is shown in a partially assembled configuration in FIG. 60, including a starter module 710, an add-on module 740 and an adjustable mounting bracket 711. Though a wire manager is not shown connected to the starter module 710, it should be understood that only one wire manager may be used, such as only in direct connection to the starter module 710, two or more wire managers may be used, no wire managers may be used, or a larger wire manager which covers both the starter module 710 and the add-on module 740 may also or alternatively be used. As shown, the starter module 710 and the add-on module 740 may be connected, such as through the use of one or more clips 714 or other connection means. The zip tabs 715 may flex into the body of the starter module 710 and/or the add-on module 740 to allow for connection and alignment, or the add-on module 740 may have one or more complementary openings or recesses to allow for alignment with the one or more zip tabs 715. The combined starter module 710 and add-on module 740 may be inserted into the mounting bracket 711 to a desired depth, wherein the bracket 711 at least partially encloses and supports both the starter module 710 and the add-on module 740. It should be understand that other shapes and sizes of mounting brackets 711 may also be used, such as ones which allow for multiple add-on modules 740 to be attached in parallel, or where additional components may be mounted below the starter module 710.

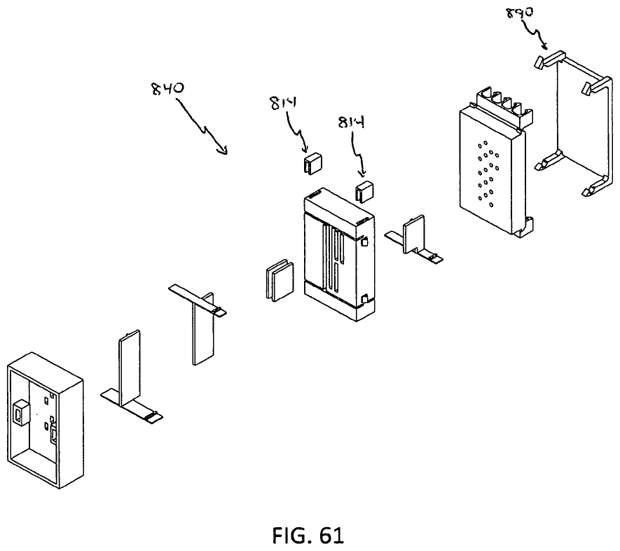

An embodiment of the add-on module 840 shown in FIG. 61 includes an optional wire manager 890 as well as two optional clip 814 for connection to other components, such as additional add-on modules 840, though it should be understood that only one clip 814 may be used, or more clips 814 could also be used, such as for improved connection or for connection along the bottom of the add-on module 840 as well. If the add-on module 840 is not in direct contact with what it is being connected to, wider clips 814 may also be used, such as if a bracket feature needs to be passed over.

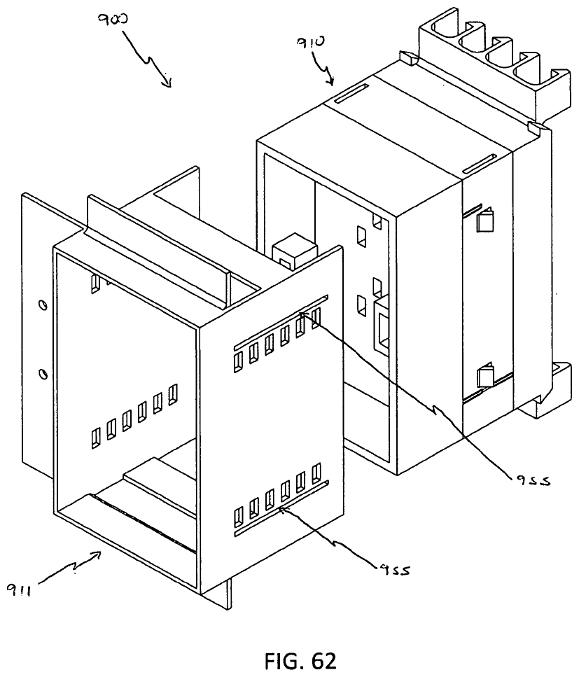

An alternate embodiment of a modular electrical connector unit 900 is shown in FIG. 62. The unit 900 includes a starter module 910 and an adjustable mounting bracket 911. As shown, the bracket 911 may be configured to allow for attachment of one or more add-on modules (not shown) after the starter module 910 has been inserted into the bracket 911. The bracket 911 may include one or more slots 955 for access for prongs or other electrical connection features from an additional add-on module to the starter module 910. The slots 955 allow for connection features to access the starter module 910 regardless of the relative positioning between the starter module 910 and the adjustable bracket 911.

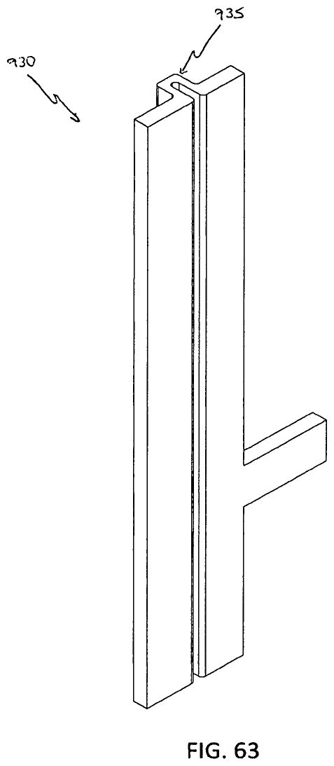

An alternate embodiment of an exemplary buss bar 930 is shown in FIG. 63. In this embodiment, the one or more ribs 935 may be formed by creating a bend in the buss bar 930, though the ribs 935 may be created through other means, such as welding, machining, and other means known in the art.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A modular connector unit, comprising:
a first side;
a second side;
a third side;
a first internal volume defined by the first side, the second side, and the third side; and
a first electrically conductive element at least partially within the first internal volume;
wherein the first electrically conductive element is configured to enable connection of at least one electrical wire from the second side to the first side.

2. The modular connector unit according to claim 1, further wherein the first side defines a first access opening.

3. The modular connector unit according to claim 2, further wherein the at least one electrical connection feature comprises at least one electrical junction, wherein the at least one electrical junction is connected to at least one connection opening proximal to the first side.

4. The modular connector unit according to claim 3, further wherein the at least one electrical junction further comprises a stab connector.

5. The modular connector unit according to claim 3, further wherein the unit comprises at least one electrical pathway extending from the at least one electrical connection feature towards at least one add-on electrical connection feature.

6. The modular connector unit according to claim 3, further comprising at least one structural connection feature.

7. The modular connector unit according to claim 3, further comprising at least one module connection feature which is proximal to the first side.

8. The modular connector unit according to claim 7, further wherein the at least one module connection feature is a snap-fit feature.

9. The modular connector unit according to claim 5, further wherein the at least one add-on electrical connection feature is configured to receive a prong from an add-on modular unit.

10. The modular connector unit according to claim 3, further wherein the at least one connection opening is configured to receive a prong from a clip-on module.

11. The modular connector unit according to claim 3, further comprising a wire guard.

12. The modular connector unit according to claim 3, further comprising at least one wire manager feature.

13. A modular connector system, comprising:
a starter unit; and
an add-on unit;
wherein the starter unit comprises at least one main electrical connection feature configured to enable connection of the starter unit to electrical wiring of a structure, a first electrical pathway configured to enable connection of secondary electrical lines to the at least electrical wiring of a structure, and a second electrical pathway configured to enable connection of tertiary electrical lines to the electrical wiring of a structure.

14. The modular connector system according to claim 13, further comprising a mounting bracket, wherein the mounting bracket comprises a first bracket wall, a second bracket wall, and a third bracket wall, the first bracket wall, the second bracket wall, and the third bracket wall define an at least partially open bracket volume, and the starter unit is at least partially insertable into the at least partially open bracket volume, and the mounting bracket is connectable to at least the starter unit.

15. The modular connector system according to claim 14, further wherein the add-on unit comprises at least one electrical connector element and the starter unit comprises a first surface defining a first opening configured to receive the at least one electrical connector element, and the starter unit comprises at least one adjustable connection feature configured to enable connection between the starter unit and the mounting bracket in two different orientations relative to either the first bracket wall, the second bracket wall, or the third bracket wall.

16. A modular connector system, comprising:
a starter unit; and
a clip-on unit;
wherein the starter unit comprises at least one main electrical connection feature configured to enable connection of the starter unit to electrical wiring of a structure and a first electrical pathway configured to enable connection of secondary electrical lines to the electrical wiring of a structure from the clip-on unit through the starter unit to the electrical wiring of a structure.

17. The modular connector system according to claim 16, further wherein the starter unit further comprises a first at least one connection feature, the clip-on unit further comprises a second at least one connection feature, and the second at least one connection feature is configured to enable connection of the clip-on unit to the starter unit.

18. The modular connector system according to claim 17, further wherein the second at least one connector feature is configured to enable removable connection with the first at least one connection feature.

19. The modular connector system according to claim 17, further comprising a face plate unit, wherein the clip-on unit further comprises a third at least one connection feature, the face plate unit further comprises a fourth at least one connection feature, and the fourth at least one connection feature is configured to enable connection of the face plate unit to the clip-on unit.

20. The modular connector system according to claim 19, further wherein the fourth at least one connector feature is configured to enable removable connection with the third at least one connection feature.
